(19) United States
(12) Patent Application Publication
(10) Pub. No.: US 2023/0389005 A1
(43) Pub. Date: Nov. 30, 2023

(54) USER EQUIPMENT INDICATION OF PREFERRED TIMING ADJUSTMENT

(71) Applicant: QUALCOMM Incorporated, San Diego, CA (US)

(72) Inventors: Qian ZHANG, Basking Ridge, NJ (US); Yan ZHOU, San Diego, CA (US); Navid ABEDINI, Basking Ridge, NJ (US); Tao LUO, San Diego, CA (US); Junyi LI, Fairless Hills, PA (US)

(21) Appl. No.: 18/314,659

(22) Filed: May 9, 2023

Related U.S. Application Data
(60) Provisional application No. 63/346,760, filed on May 27, 2022.

(51) Int. Cl. H04W 72/1263; H04W 72/541

(52) U.S. Cl. CPC H04W 72/1263; H04W 72/541

(57) ABSTRACT

Methods, systems, and devices for wireless communications are described. Some wireless communications systems may support user equipment (UE) indication of preferred timing adjustment. In some case, a first UE may receive, from a network entity, a downlink message. Additionally, the first UE may receive a first level of interference at the first UE, where the first level of interference is based on an uplink message transmitted from a second UE and at least partially overlaps in time with the downlink message. In some cases, the first UE may transmit, to the network entity, assistance information associated with a timing adjustment based on the first level of interference, where the timing adjustment is associated with one or more uplink messages to be transmitted from the second UE.

### CROSS REFERENCE

The present Application for Patent claims the benefit of U.S. Provisional Patent Application No. 63/346,760 by ZHANG et al., entitled “USER EQUIPMENT INDICATION OF PREFERRED TIMING ADJUSTMENT,” filed May 27, 2022, assigned to the assignee hereof, and expressly incorporated by reference herein.

### FIELD OF TECHNOLOGY

The following relates to wireless communications, including user equipment (UE) indication of preferred timing adjustment.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support user equipment indication of preferred timing adjustment. Generally, the described techniques provide for a first user equipment (UE) to transmit assistance information associated with a timing adjustment for a second UE based on interference at the first UE. For example, the first UE may receive, from a network entity, a downlink message. Additionally, the first UE may receive a first level of interference based on an uplink message transmitted from a second UE. That is, the uplink message transmitted from the second UE may cause cross-link interference (CLI) at the first UE, which the first UE may receive as the first level of interference. Additionally, the first level of interference may overlap at least partially in time with the downlink message, however, the first UE may receive the first level of interference at a time offset from receiving the downlink message. In some cases, the first UE may transmit, to the network entity, assistance information associated with a timing adjustment based on the first level of interference, where the timing adjustment is associated with additional uplink messages to be transmitted from the second UE. That is, the first UE may transmit assistance information associated with a preferred timing adjustment for the second UE such that, if applied, the time offset between receiving a second downlink signal and receiving a second level of interference (associated with an additional uplink message) may be less than a threshold. In some cases, the assistance information may indicate a value associated with a timing adjustment. In some other cases, the assistance information may include a timing report indicating a time offset between receiving the downlink signal and receiving the first level of interference.

A method for wireless communications at a first user equipment (UE) is described. The method may include receiving, from a network entity, a downlink message at the first UE, receiving a first level of interference at the first UE, where the first level of interference is based on an uplink message transmitted from a second UE and where the first level of interference at least partially overlaps in time with the downlink message, and transmitting, to the network entity, assistance information associated with a timing adjustment based on the first level of interference, where the timing adjustment is associated with one or more uplink messages to be transmitted from the second UE.

An apparatus for wireless communications at a first UE is described. The apparatus may include a processor, memory coupled with the processor, and instructions stored in the memory. The instructions may be executable by the processor to cause the apparatus to receive, from a network entity, a downlink message at the first UE, receive a first level of interference at the first UE, where the first level of interference is based on an uplink message transmitted from a second UE and where the first level of interference at least partially overlaps in time with the downlink message, and transmit, to the network entity, assistance information associated with a timing adjustment based on the first level of interference, where the timing adjustment is associated with one or more uplink messages to be transmitted from the second UE.

Another apparatus for wireless communications at a first UE is described. The apparatus may include means for receiving, from a network entity, a downlink message at the first UE, means for receiving a first level of interference at the first UE, where the first level of interference is based on an uplink message transmitted from a second UE and where the first level of interference at least partially overlaps in time with the downlink message, and means for transmitting, to the network entity, assistance information associated with a timing adjustment based on the first level of interference, where the timing adjustment is associated with one or more uplink messages to be transmitted from the second UE.

A non-transitory computer-readable medium storing code for wireless communications at a first UE is described. The code may include instructions executable by a processor to receive, from a network entity, a downlink message at the first UE, receive a first level of interference at the first UE, where the first level of interference is based on an uplink message transmitted from a second UE and where the first level of interference at least partially overlaps in time with the downlink message, and transmit, to the network entity, assistance information associated with a timing adjustment based on the first level of interference, where the timing adjustment is associated with one or more uplink messages to be transmitted from the second UE.

Some examples of the method, apparatuses, and non-transitory computer-readable medium described herein may further include operations, features, means, or instructions for comparing timing associated with reception of the downlink message to timing associated with reception of the first level of interference, where the assistance information may be based on the comparison.

In some examples of the method, apparatuses, and non-transitory computer-readable medium described herein, transmitting the assistance information may include operations, features, means, or instructions for transmitting an indication of a value associated with the timing adjustment for the second UE, where the value associated with the timing adjustment may be based on the comparison.

In some examples of the method, apparatuses, and non-transitory computer-readable medium described herein, transmitting the assistance information may include operations, features, means, or instructions for transmitting an indication of a timing report, where the timing report includes an indication of a difference between the timing associated with the reception of the downlink message and the timing associated with the reception of the first level of interference based on the comparison.

In some examples of the method, apparatuses, and non-transitory computer-readable medium described herein, transmitting the assistance information may include operations, features, means, or instructions for transmitting, to the network entity, the assistance information associated with the timing adjustment based on a difference between the timing associated with the reception of the downlink message and the timing associated with the reception of the first level of interference exceeding a threshold, where the difference may be based on the comparison.

Some examples of the method, apparatuses, and non-transitory computer-readable medium described herein may further include operations, features, means, or instructions for measuring the first level of interference, where transmitting the assistance information may be based on the first level of interference exceeding a threshold.

Some examples of the method, apparatuses, and non-transitory computer-readable medium described herein may further include operations, features, means, or instructions for receiving, from the network entity, control signaling including an indication of the threshold.

In some examples of the method, apparatuses, and non-transitory computer-readable medium described herein, the threshold may be based on one or more parameters at the first UE.

In some examples of the method, apparatuses, and non-transitory computer-readable medium described herein, transmitting the assistance information may include operations, features, means, or instructions for transmitting an indication of one or more parameters associated with the downlink message, the uplink message, or both, where the assistance information includes the one or more parameters.

In some examples of the method, apparatuses, and non-transitory computer-readable medium described herein, the one or more parameters may be associated with one or more guard bands, one or more guard symbols, one or more power control parameters, or any combination thereof.

Some examples of the method, apparatuses, and non-transitory computer-readable medium described herein may further include operations, features, means, or instructions for receiving, from the network entity, a second downlink message at the first UE and receiving a second level of interference at the first UE based on the one or more uplink messages transmitted from the second UE, where the second level of interference may be based on the assistance information.

In some examples of the method, apparatuses, and non-transitory computer-readable medium described herein, the second level of interference may be less than a threshold.

In some examples of the method, apparatuses, and non-transitory computer-readable medium described herein, the downlink message may be associated with a first transmission timing, and receiving the second downlink message may include operations, features, means, or instructions for receiving the second downlink message associated with a second transmission timing, where the second transmission timing may be based on the assistance information.

Some examples of the method, apparatuses, and non-transitory computer-readable medium described herein may further include operations, features, means, or instructions for receiving, from the network entity, a control message indicating the second transmission timing, where receiving the second downlink message may be based on the control message.

In some examples of the method, apparatuses, and non-transitory computer-readable medium described herein, a difference between timing associated with the reception of the second downlink message and timing associated with the reception of the second level of interference may be below a threshold.

In some examples of the method, apparatuses, and non-transitory computer-readable medium described herein, the downlink message may be associated with a first sub-band and the uplink message may be associated with a second sub-band.

Some examples of the method, apparatuses, and non-transitory computer-readable medium described herein may further include operations, features, means, or instructions for receiving, from the network entity, a feedback message indicating whether the network entity applied the timing adjustment to the second UE based on receiving the assistance information.

A method for wireless communications at a network entity is described. The method may include transmitting, to a first UE, a downlink message, where a first level of interference is associated with the downlink message, the first level of interference based on an uplink message transmitted from a second UE and receiving assistance information associated with a timing adjustment based on the first level of interference, where the timing adjustment is associated with one or more uplink message to be transmitted from the second UE.

An apparatus for wireless communications at a network entity is described. The apparatus may include a processor, memory coupled with the processor, and instructions stored in the memory. The instructions may be executable by the processor to cause the apparatus to transmit, to a first UE, a downlink message, where a first level of interference is associated with the downlink message, the first level of interference based on an uplink message transmitted from a second UE and receive assistance information associated with a timing adjustment based on the first level of interference, where the timing adjustment is associated with one or more uplink message to be transmitted from the second UE.

Another apparatus for wireless communications at a network entity is described. The apparatus may include means for transmitting, to a first UE, a downlink message, where a first level of interference is associated with the downlink message, the first level of interference based on an uplink message transmitted from a second UE and means for receiving assistance information associated with a timing adjustment based on the first level of interference, where the timing adjustment is associated with one or more uplink message to be transmitted from the second UE.

A non-transitory computer-readable medium storing code for wireless communications at a network entity is described. The code may include instructions executable by a processor to transmit, to a first UE, a downlink message, where a first level of interference is associated with the downlink message, the first level of interference based on an uplink message transmitted from a second UE and receive assistance information associated with a timing adjustment based on the first level of interference, where the timing adjustment is associated with one or more uplink message to be transmitted from the second UE.

Some examples of the method, apparatuses, and non-transitory computer-readable medium described herein may further include operations, features, means, or instructions for receiving the uplink message from the second UE according to a first TA and determining whether to apply the timing adjustment to the second UE, where the timing adjustment may be based on the assistance information.

Some examples of the method, apparatuses, and non-transitory computer-readable medium described herein may further include operations, features, means, or instructions for applying the timing adjustment to the second UE based on a value associated with the timing adjustment, where determining to apply the timing adjustment may be based on the value being less than or equal to a threshold.

In some examples of the method, apparatuses, and non-transitory computer-readable medium described herein, applying the timing adjustment may include operations, features, means, or instructions for transmitting, to the second UE, a control message indicating a second TA, where the second TA may be based on the value associated with the timing adjustment and receiving a second uplink message from the second UE according to the second TA.

In some examples of the method, apparatuses, and non-transitory computer-readable medium described herein, the downlink message may be associated with a first transmission timing and the method, apparatuses, and non-transitory computer-readable medium may include further operations, features, means, or instructions for transmitting a second downlink message according to a second transmission timing, where the second transmission timing may be based on a value associated with the timing adjustment.

In some examples of the method, apparatuses, and non-transitory computer-readable medium described herein, receiving the assistance information may include operations, features, means, or instructions for receiving an indication of a value associated with the timing adjustment for the second UE, where the assistance information includes the indication.

In some examples of the method, apparatuses, and non-transitory computer-readable medium described herein, receiving the assistance information may include operations, features, means, or instructions for receiving an indication of a timing report, where the timing report includes an indication of a difference between timing associated with reception of the downlink message by the first UE and timing associated with reception of the first level of interference by the first UE, where the assistance information includes the timing report.

In some examples of the method, apparatuses, and non-transitory computer-readable medium described herein, receiving the assistance information may include operations, features, means, or instructions for receiving an indication of one or more parameters associated with the downlink message, the uplink message, or both, where the assistance information includes the one or more parameters.

In some examples of the method, apparatuses, and non-transitory computer-readable medium described herein, the one or more parameters may be associated with one or more guard bands, one or more guard symbols, one or more power control parameters, or any combination thereof.

Some examples of the method, apparatuses, and non-transitory computer-readable medium described herein may further include operations, features, means, or instructions for transmit, to a second network entity, the assistance information associated with the timing adjustment, where the second network entity may be associated with the uplink message.

In some examples of the method, apparatuses, and non-transitory computer-readable medium described herein, the first level of interference exceeds a threshold.

In some examples of the method, apparatuses, and non-transitory computer-readable medium described herein, the downlink message may be associated with a first sub-band and the uplink message may be associated with a second sub-band.

Some examples of the method, apparatuses, and non-transitory computer-readable medium described herein may further include operations, features, means, or instructions for transmitting, to the first UE, a control message including an indication of a threshold associated with interference at the first UE.

### BRIEF DESCRIPTION OF THE DRAWINGS

FIG. 1 illustrates an example of a wireless communications system that supports user equipment (UE) indication of preferred timing adjustment in accordance with one or more aspects of the present disclosure.

FIGS. 2A, 2B, and 2C each illustrate an example of a wireless communications system that supports UE indication of preferred timing adjustment in accordance with one or more aspects of the present disclosure.

FIGS. 3A and 3B each illustrate an example of a full-duplex operation scheme that supports UE indication of preferred timing adjustment in accordance with one or more aspects of the present disclosure.

FIG. 4 illustrates an example of a wireless communications system that supports UE indication of preferred timing adjustment in accordance with one or more aspects of the present disclosure.

FIGS. 5 and 6 each illustrate an example of a process flow that supports UE indication of preferred timing adjustment in accordance with one or more aspects of the present disclosure.

FIGS. 7 and 8 show block diagrams of devices that support UE indication of preferred timing adjustment in accordance with one or more aspects of the present disclosure.

FIG. 9 shows a block diagram of a communications manager that supports UE indication of preferred timing adjustment in accordance with one or more aspects of the present disclosure.

FIG. 10 shows a diagram of a system including a device that supports UE indication of preferred timing adjustment in accordance with one or more aspects of the present disclosure.

FIGS. 11 and 12 show block diagrams of devices that support UE indication of preferred timing adjustment in accordance with one or more aspects of the present disclosure.

FIG. 13 shows a block diagram of a communications manager that supports UE indication of preferred timing adjustment in accordance with one or more aspects of the present disclosure.

FIG. 14 shows a diagram of a system including a device that supports UE indication of preferred timing adjustment in accordance with one or more aspects of the present disclosure.

FIGS. 15 through 18 show flowcharts illustrating methods that support UE indication of preferred timing adjustment in accordance with one or more aspects of the present disclosure.

### DETAILED DESCRIPTION

In some wireless communications systems, a wireless device, such as a user equipment (UE) or a network entity, may support wireless communications over one or multiple radio access technologies (RATs). In such cases, the wireless device may operate in a half-duplex mode, a full-duplex mode, or a combination thereof. In a half-duplex mode, the wireless device may either transmit communications or receive communications during a time period, such as a transmission time interval (TTI) that may span one or more time resources (e.g., symbols, mini-slots, slots, etc.). In a full-duplex mode, the wireless device may simultaneously transmit and receive communications during the time period. That is, communications received by the wireless device may at least partially overlap in the time domain with communications transmitted by the wireless device. For example, symbols occupied by received signals may overlap with symbols occupied by transmitted signals.

In some examples, neighboring wireless devices (e.g., UEs, network entities, or the like) may perform full-duplex communications or half-duplex time division duplexing (TDD) concurrently, such that communications received by a first wireless device (from a network entity) may overlap in time with communications transmitted by a second wireless device (e.g., a neighboring wireless device). In such an example, the communications transmitted by the second wireless device may interfere with the communications received at the first wireless device. Such interference may be referred to as cross-link interference (CLI) or other similar terminology. In some examples, CLI may degrade wireless communications between the first wireless device and the network entity.

Various aspects of the present disclosure generally relate to techniques for transmitting assistance information indicating a preferred timing adjustment to support interference mitigation. For example, a network entity may communicate with a first UE over a downlink communications channel and may communicate with a second UE over an uplink communications channel. Additionally, the network entity may operate in a full-duplex mode and may transmit a downlink message to the first UE while simultaneously receiving an uplink message from the second UE. In some cases, the first UE may receive, from the network entity, the downlink message and receive interference due to the uplink message transmitted by the second UE, where the interference overlaps at least partially in time with the downlink message. In some cases, the interference may be greater than a threshold and the first UE may transmit, to the network entity, assistance information associated with a timing adjustment, where the timing adjustment is associated with one or more uplink messages to be transmitted from the second UE. That is, the first UE may transmit the assistance information to the network entity such that the network entity may determine whether to adjust a timing advance (TA) of the second UE. In such cases (e.g., if adjusted), the first UE may receive additional downlink messages at the same time that the first UE receives interference associated with additional uplink messages. That is, reception of the additional downlink messages at the first UE may be in alignment with reception of the interference associated with the additional uplink messages at the first UE, which may reduce impacts of CLI.

Aspects of the disclosure are initially described in the context of wireless communications systems. Aspects of the disclosure are them described in the context of full-duplex operation schemes and process flows. Aspects of the disclosure are further illustrated by and described herein with reference to apparatus diagrams, system diagrams, and flowcharts that relate to user equipment indication of preferred timing advance.

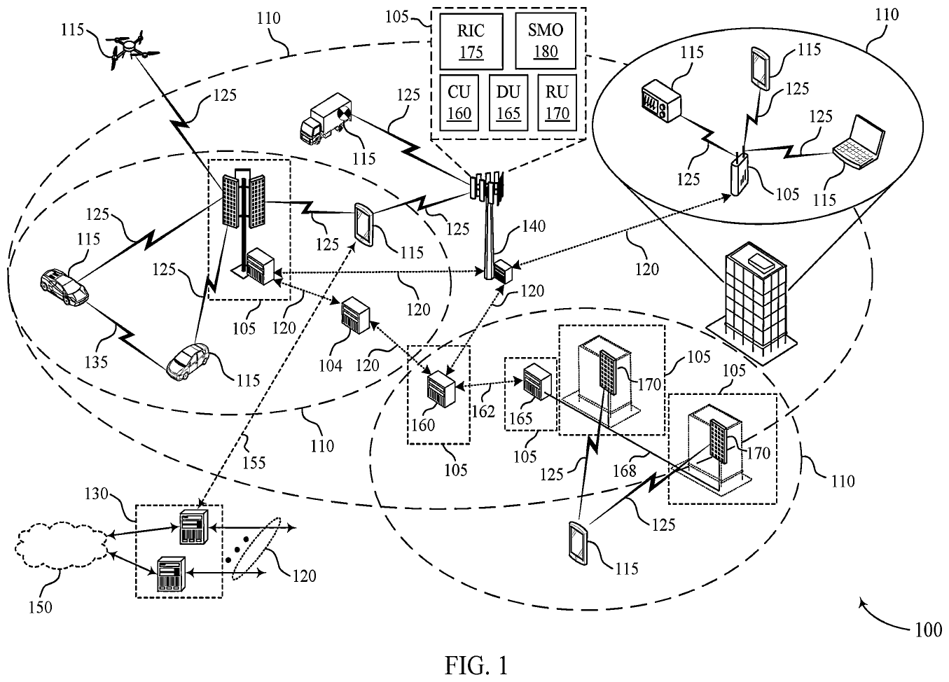

FIG. 1 illustrates an example of a wireless communications system 100 that supports UE indication of preferred timing adjustment in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more RATs.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support UE indication of preferred timing adjustment as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ, may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N f) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, the wireless communications system 100 may support transmission of assistance information associated with a preferred timing adjustment in accordance with the techniques described herein. For example, a network entity 105 may transmit a downlink message to a first UE 115 while simultaneously receiving an uplink message from a second UE 115. In some cases, the uplink message transmitted by the second UE 115 may cause interference at the first UE 115. That is, the first UE 115 may simultaneously receive the downlink message from the network entity 105 and interference associated with the uplink from the second UE 115 (e.g., the interference may at least partially overlap in time with the downlink message). However, the time at which the first UE 115 receives the interference may be different than (e.g., offset from) the time that the first UE 115 receives the downlink message, resulting in a misalignment (e.g., a loss of orthogonality) between the interference and the downlink. In such cases, the first UE 115 may transmit, to the network entity 105, assistance information associated with a timing adjustment based on the interference. That is, the first UE 115 may transmit an indication of a timing adjustment (e.g., a TA adjustment) for one or more uplink messages of the second UE 115, such that the first UE 115 may receive the interference at the same time the first UE 115 receives downlink messages from the network entity 105. Receiving the interference at the same time as the downlink messages (e.g., resulting in alignment) may enable the first UE 115 to perform interference mitigation, reducing interference at the first UE 115.

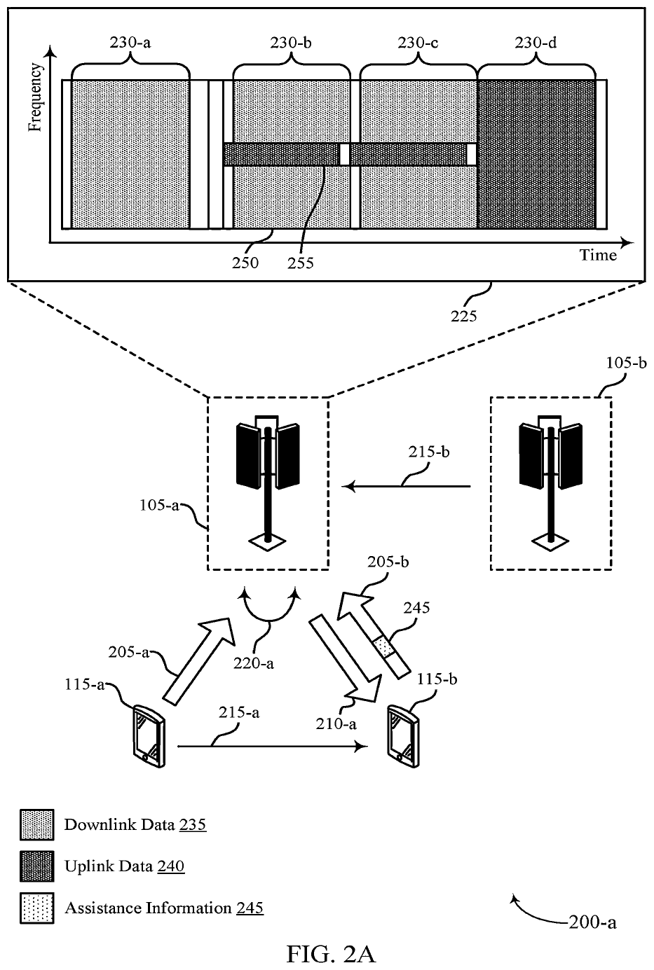

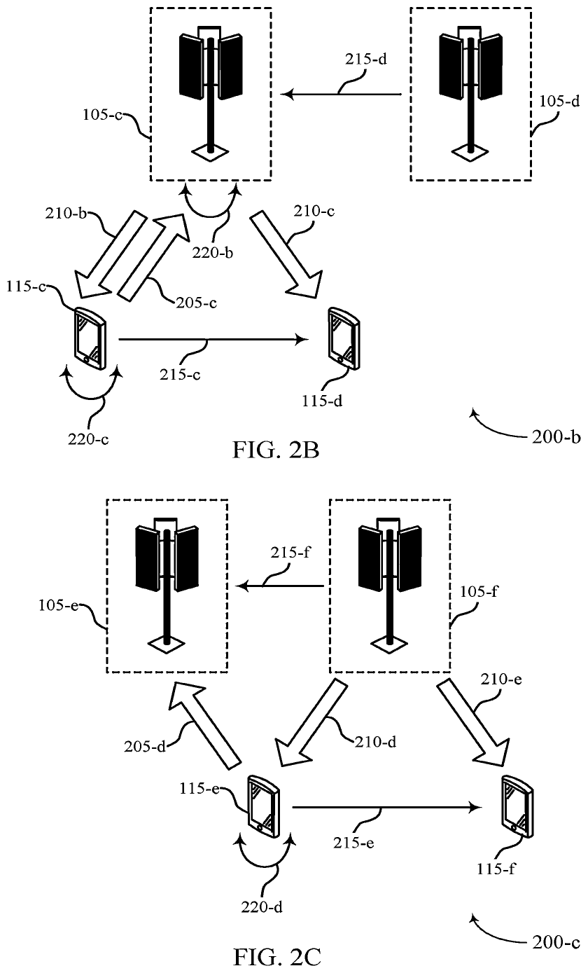

FIGS. 2A, 2B, and 2C each illustrate an example of a wireless communications system 200 that supports UE indication of preferred timing adjustment in accordance with one or more aspects of the present disclosure. In some examples, the wireless communications systems 200 (e.g., a wireless communications system 200-a, a wireless communications system 200-b, and a wireless communications system 200-c) may implement aspects of the wireless communications system 100. For example, the wireless communications systems 200 may each include one or more network entities 105 (e.g., a network entity 105-a, a network entity 105-b, a network entity 105-c, a network entity 105-d, a network entity 105-e, and a network entity 105-f) and one or more UEs 115 (e.g., a UE 115-a, a UE 115-b, a UE 115-c, a UE 115-d, a UE 115-e, and a UE 115-f), which may be examples of the corresponding devices as described herein with reference to FIG. 1. In the example of FIGS. 2A, 2B, and 2C, the network entities 105 may be examples of a CU 160, a DU 165, an RU 170, a base station 140, an IAB node 104, or one or more other network nodes as described herein with reference to FIG. 1. The wireless communications systems 200 may include features for improved communications between the UEs 115 and the network, among other benefits.

In the examples of FIGS. 2A, 2B, and 2C, the UEs 115 and the network entities 105 may communicate via one or more communication links 205 (e.g., a communication link 205-a, a communication link 205-b, a communication link 205-c, and a communication link 205-d) and via one or more communication links 210 (e.g., a communication link 210-a, a communication link 210-b, a communication link 210-c, a communication link 210-d, and a communication link 210-e). The communication links 205 may be examples of uplinks and the communication links 210 may be examples of downlinks. Additionally, or alternatively, the communication links 205 and the communication links 210 may each be examples of a communication link 125 as described herein with reference to FIG. 1. Each wireless communications system 200 may illustrate communication devices (e.g., one or more UEs 115, one or more network entities 105) operating in a full-duplex mode (e.g., performing full-duplex wireless communications) or a half-duplex TDD mode (e.g., performing half-duplex TDD wireless communications). That is, full-duplex (or half-duplex TDD) capabilities may be present at one or more network entities 105, one or more UEs 115 (or both). For example, the wireless communications systems 200 may support TDD radio frequency bands (e.g., radio frequency spectrum bands configured for TDD communications), FDD radio frequency bands (e.g., radio frequency spectrum bands configured for FDD communications), full-duplex communications at one or more network entities 105 (and/or one or more UEs 115), half-duplex communications at one or more UE 115, or any combination thereof.

Each wireless communications system 200 may support multiple types of full-duplex operations. For example, a communication device operating within the wireless communications systems 200 (e.g., a network entity 105, a UE 115) may support in-band full-duplex (IBFD) operations, sub-band FDD (SBFD) operations (e.g., frequency duplex operations), or both. In some examples of IBFD operations, the communication device may transmit and receive wireless communications on a same time and frequency resource (e.g., a same slot and component carrier bandwidth). For example, downlink communications and uplink communications may share time and frequency resources (e.g., IBFD time and frequency resources). In some examples, the time and frequency resources may partially overlap or fully overlap. Additionally, or alternatively, for SBFD operations, the communications device may transmit and receive communications at over a same time resource and one or more different frequency resources. That is, the downlink resources may be separated from the uplink resource in the frequency domain.

In the example of FIG. 2A, the network entity 105-a may support SBFD operations, such that downlink communications transmitted by the network entity 105-a (e.g., to the UE 115-b) may overlap in time with uplink communications received by the network entity 105-a (e.g., from the UE 115-a). In some examples, the network entity 105-a may configure communications for the UE 115-a and the UE 115-b according to the resource structure 225. The resource structure 225 may include time domain resources (e.g., slots, symbols) allocated for downlink data 235 (e.g., a time domain resource 230-a), time domain resources allocated for uplink data 240 (e.g., a time domain resource 230-d), and one or more time domain resources allocated for both downlink data 235 and uplink data 240 (e.g., a time domain resource 230-b and a time domain resource 230-c).

In some examples, the time domain resources 230 allocated for both downlink data 235 and uplink data 240 (e.g., the time domain resource 230-b and the time domain resource 230-c) may be referred to as D+U slots (or D+U symbols). In some examples, a D+U slot may include half-duplex symbols (e.g., downlink symbols or uplink symbols) or full-duplex symbols (e.g., both downlink symbols and uplink symbols). For example, the time domain resource 230-b and the time domain resource 230-c (e.g., D+U slots) may be examples of slots, in which a radio frequency band is used for both transmitting uplink communications (e.g., uplink transmissions) and transmitting downlink communications (e.g., downlink transmissions). In some examples, the uplink transmissions and the downlink transmissions may occur in overlapping bands (e.g., for IBFD operations) or adjacent bands (e.g., for SBFD operations).

For SBFD operations in which uplink transmissions and downlink transmissions occur in adjacent bands, a half-duplex communication device may either transmit in an uplink radio frequency band or receive in a downlink radio frequency band. That is, for a given time domain resource (e.g., for a given D+U slot or a given D+U symbol), such as the time domain resource 230-b, the half-duplex device (e.g., the UE 115-a, the UE 115-b) may transmit uplink data 240 (e.g., perform a PUSCH transmission) in the uplink radio frequency band 255 or receive downlink data 235 the downlink radio frequency band 250. For example, the UE 115-a may transmit uplink data 240 in the uplink radio frequency band 255, while the UE 115-b receives downlink data 235 the downlink radio frequency band 250.

Additionally, or alternatively, for SBFD operations in which uplink and downlink transmissions occur in adjacent bands, a full-duplex device may transmit in the uplink radio frequency band and receive in the downlink radio frequency band. That is, for a given time domain resource (e.g., for a given D+U slot or a given D+U symbol), such as the time domain resource 230-b, the full-duplex device may transmit uplink data 240 (e.g., perform a PUSCH transmission) in the uplink radio frequency band 255 and receive downlink data 235 the downlink radio frequency band 250. In the example of FIG. 2B, the UE 115-c (e.g., a full-duplex device) may transmit communications in an uplink radio frequency band, while receiving communications in a downlink radio frequency band (e.g., over a same D+U slot or a same D+U symbol).

In some examples, full-duplex communications may provide for latency reduction. For example, latency savings may be enabled by receiving downlink signal in uplink slots. Moreover, full-duplex communications may provide for spectrum efficiency enhancement (e.g., per cell or per UE), efficient resource utilization, and coverage extension, among other benefits. In some examples, however, full-duplex communications may lead to one or more types of interference, such as inter-cell interference (e.g., from neighboring communication devices), self-interference (e.g., for full-duplex communication devices), and CLI (e.g., inter-cell CLI or intra-cell CLI). For example, a communication device (e.g., one or more network entities 105, one or more UEs 115) may experience self-interference 220 (e.g., a self-interference 220-a, a self-interference 220-b, a self-interference 220-c, and a self-interference 220-d) between a pair of beams, such as a beam used for transmitting communications and a beam used for receiving communications. In some examples, self-interference may result from signal leakage between an antenna panel used to transmit communications and an antenna panel used to receive communications.

Additionally, or alternatively, neighboring communication devices (e.g., neighboring UEs 115, neighboring network entities 105) may perform full-duplex communications (or half-duplex TDD) concurrently, such that communications received by a first communication device may overlap in time with communications transmitted by a second communication device (e.g., a neighboring communication device). In such an example, the communications transmitted by the second communication device may interfere with the communications received at the first communication device. For example, the communications transmitted by the second communication device may cause CLI at the first communications device. In some examples, CLI (e.g., CLI 215-a, CLI 215-b, CLI 215-c, CLI 215-d, CLI 215-e, or CLI 215-f) may result from energy leakage between the neighboring communication devices.

Additionally or alternatively CLI may result from automatic gain control (AGC) mismatch (e.g., misalignment). For example, as illustrated in the example of FIG. 2A, the AGC of the UE 115-b may be driven (e.g., controlled) by downlink communications from a serving cell (e.g., the network entity 105-a). In such an example, uplink communications transmitted from the UE 115-a may saturate the AGC of the UE 115-b, resulting in a misalignment (e.g., a loss of orthogonality) of the downlink communications received by the UE 115-b and the uplink communications transmitted by the UE 115-a. In some examples, the misalignment of the downlink communications and the uplink communications may lead to CLI 215-a at the UE 115-b.

In some examples, the network entity 105-a may be operating in a full-duplex mode (e.g., SBFD or IBFD) and the UEs 115 (e.g., the UE 115-a and the UE 115-b) may be operating in a half-duplex mode. For example, the network entity 105-a may receive uplink communications from the UE 115-a (e.g., via the communication link 205-a), while simultaneously transmitting downlink communications to a UE 115-b (e.g., via the communication link 210-a). In such an example, the full-duplex communications at the network entity 105-a may lead to self-interference 220-a. Additionally, or alternatively, the network entity 105-a and the network entity 105-b (e.g., neighboring network entities) may concurrently perform full-duplex communications, such that downlink signals transmitted by the network entity 105-b may overlap with uplink signals received by the network entity 105-a, leading to CLI 215-b.

Additionally, or alternatively, the UE 115-a and the UE 115-b (e.g., neighboring UEs) may concurrently perform half-duplex TDD communications such that uplink signals transmitted by the UE 115-b may overlap with downlink signals received by the UE 115-a, which may lead to CLI 215-a. In some examples, the UE 115-a may be operating in a cell different from the cell in which the UE 115-b may be operating. For example, the UE 115-a and the UE 115-b may be operating in adjacent cells. In an example, the CLI 215-a may be an example of inter-cell CLI. Additionally, or alternatively, the network entity 105-b may perform full-duplex communications concurrently with the network entity 105-a. In such an example, downlink communications transmitted by the network entity 105-b may lead to inter-cell interference at the UE 115-b. For example, the downlink communications transmitted by the network entity 105-b (e.g., to another UE (not shown)) may interfere with downlink communications received the UE 115-b (e.g., from the network entity 105-a).

In some other examples, the UE 115-a and the UE 115-b may be operating in a same cell. In such an example, the CLI 215-a may be an example of intra-cell CLI. For example, the network entity 105-a may be operating in a full-duplex mode (e.g., in SBFD), such that the network entity 105-a may configure downlink communications for the UE 115-a in frequency domain resources adjacent to the frequency domain resources allocated for uplink communications from the UE 115-b. For example, the network entity 105-a may configure the UE 115-b to receive downlink data 235 (e.g., from the network entity 105-a) in the time domain resource 230-b and in the downlink radio frequency band 250 and the UE 115-a may be configured to transmit uplink data 240 in the time domain resource 230-b in the uplink radio frequency band 255 (e.g., the adjacent frequency resources). In such an example, the uplink communications transmitted by the UE 115-a may interfere with the downlink communications received at the UE 115-b.

In the example of FIG. 2B, the network entity 105-c and the UE 115-c may each be operating in a full-duplex mode (e.g., IBDF), such that the UE 115-c may receive downlink communications from the network entity 105-c via the communication link 210-b, while simultaneously transmitting uplink communications to the network entity 105-c via the communication link 205-c. In such an example, the full-duplex communications at the network entity 105-c and the full-duplex communications at the UE 115-c may lead to self-interference 220-b and self-interference 220-c, respectively. In some examples of the wireless communications system 200-b, the UE 115-c and the UE 115-d may each be operating in a multiple transmission and reception mode. In such an example, downlink communications and uplink communications performed by the network entity 105-c may occur at two different antenna panels located at two transmission and reception points. For example, the reception of uplink communications from the UE 115-c a may occur at an antenna panel of a first transmission and reception point and the transmission of downlink communications to the UE 115-c may occur at an antenna panel of a second transmission and reception point. In some other examples, reception of the uplink communications and transmission of the downlink communications may occur at two co-located antenna panels of the network entity 105-c (e.g., a single base station).

In the example of FIG. 2C, the UE 115-e may be operating in a full-duplex mode (e.g., SBFD), such that the UE 115-e may receive downlink communications from the network entity 105-f via the communication link 210-d, while simultaneously transmitting uplink communications to the network entity 105-e via the communication link 205-d. In such an example, the full-duplex communications at the UE 115-e may lead to self-interference 220-d. In some examples of the wireless communications system 200-c, the network entity 105-e and the network entity 105-f may be examples of transmission and reception points and the UE 115-e (e.g., and the UE 115-f) may be operating in a multiple transmission and reception mode. In such an example, the uplink communications transmitted from the UE 115-e may lead to CLI 215-e (e.g., intra-cell CLI) at the UE 115-f.

In some examples, to reduce interference within the wireless communications systems 200, the UE 115-b may transmit, to the network entity 105-a, assistance information associated with a timing adjustment in accordance with the techniques described herein. For example, the network entity 105-a may transmit a downlink message to the UE 115-b while simultaneously receiving an uplink message from the UE 115-a. In some cases, the uplink message transmitted by the UE 115-a may cause CLI 215-a at the UE 115-b. That is, the UE 115-b may simultaneously receive the downlink message from the network entity 105-a and the CLI 215-a (e.g., the downlink message and the CLI 215-a at least partially overlap in time). However, the time at which the UE 115-b receives the CLI 215-a may be different than the time that the UE 115-b receives the downlink message resulting in a misalignment (e.g., a loss of orthogonality) between the CLI 215-a and the downlink message. In such cases, the UE 115-b may transmit, to the network entity 105-a, assistance information 245 associated with a timing adjustment based on the CLI 215-a. That is, the UE 115-b may transmit an indication of a timing adjustment for one or more uplink messages of the UE 115-a, such that the UE 115-b may receive the CLI 215-a at the same time the UE 115-b receives downlink messages from the network entity 105-a. Receiving the CLI 215-a at the same time as the downlink messages may enable the UE 115-b to perform interference mitigation, reducing interference at the UE 115-b.

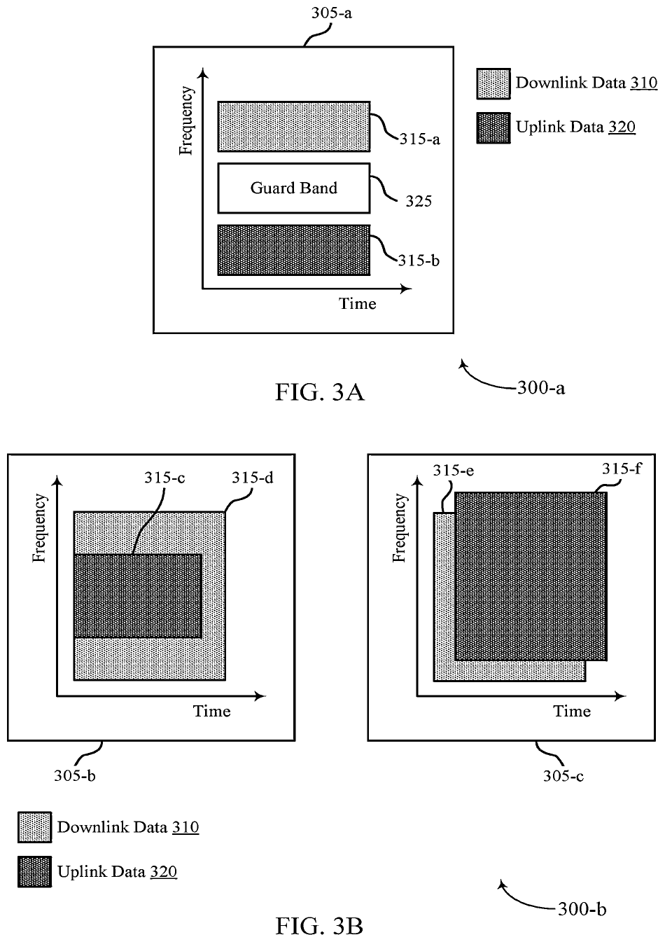

FIGS. 3A and 3B illustrates an example of a full-duplex operation scheme 300 that supports UE indication of preferred timing adjustment in accordance with one or more aspects of the present disclosure. In some examples, the full-duplex operation schemes 300 (a full-duplex operation scheme 300-a and a full-duplex operation scheme 300-b) may implement or be implemented by aspects of the wireless communications system 100. For example, the full-duplex operation schemes 300 may each be implemented by a network entity or a UE, which may be examples of the corresponding devices as described herein with reference to FIG. 1. In some examples of FIGS. 3A and 3B, the network entity may be an example of a CU 160, a DU 165, an RU 170, a base station 140, an IAB node 104, or one or more other network nodes as described herein with reference to FIG. 1. The full-duplex operation schemes 300 may include features for improved communications between the UE and the network, among other benefits.

In some examples, a wireless communications device (e.g., the network entity or the UE) may support full-duplex communications, in which the communication device may transmit and receive communication simultaneously, thereby promoting latency savings enabled by receiving downlink signal in uplink slots (or symbols). In some examples, the communication device may support multiple (e.g., two) types of full-duplex operations. For example, the communication device may support SBFD operations, in which the communication device may transmit and receive communications over a same time resource and on different frequency resources. That is, the downlink resources may be separated from the uplink resource in the frequency domain.

For example, as illustrated by the example of FIG. 3A, the network may configure one or more UEs in accordance with the configuration 305-a. In such an example, the network may configure downlink transmissions (e.g., transmissions of downlink data 310) for the UE in frequency domain resources (e.g., a resource 315-a) that may be adjacent to frequency domain resources (e.g., a resource 315-b) configured for uplink transmission (e.g., transmissions of uplink data 320) of another UE. In some examples, to reduce interference between the uplink transmissions (e.g., scheduled for the resource 315-a) and the downlink transmissions (e.g., scheduled for the resource 315-b), the network may configure the resource 315-a and the resource 315-b to be separated by a guard band 325.

Additionally, or alternatively, as illustrated in the example of FIG. 3B, the network (e.g., the network entity) may support IBFD operations, such that the network entity may transmit and receive communications on a same time resource and a same frequency resource (e.g., a same slot and carrier bandwidth). For example, the network may configure one or more UEs in accordance with the configuration 305-b, the configuration 305-c, or both. In such an example, the network may configure downlink transmissions (e.g., transmission of the downlink data 310) and the uplink transmissions (e.g., transmission of the uplink data 320), such that the downlink transmission and the uplink transmissions may share a same one or more time and frequency resources (e.g., IBFD time and frequency resources). In some examples, the network may configure one or more UEs in accordance with the configuration 305-b, such that one or more time and frequency resources allocated for transmission of the uplink data 320 (e.g., a resource 315-c) may overlap (e.g., fully overlap) with one or more time and frequency resources allocated for transmission of the downlink data 310 (e.g., a resource 315-d). Additionally, or alternatively, the network may configure one or more UEs in accordance with the configuration 305-c, such that a portion of the one or more time and frequency resources allocated for transmission of the uplink data 320 (e.g., a resource 315-e) may overlap with a portion of the one or more time and frequency resources allocated for transmission of the downlink data 310 (e.g., a resource 315-f). That is, the resource 315-e) may partially overlap with the resource 315-f.

In some examples, while full-duplex communications may provide for one or more spectrum efficiency enhancements (e.g., per cell or per UE), efficient resource utilization, and coverage area extension, concurrent full-duplex communications performed by neighboring communication devices may lead to interference (e.g., CLI). For example, neighboring wireless devices may perform communications concurrently, such that communications received by a first wireless device, such as a first UE 115, may overlap in time with communications transmitted by a second wireless device (e.g., a neighboring communication device), such as a second UE 115. In such an example, the communications transmitted by the second UE 115 may lead to interference (e.g., CLI) at the first UE 115. In some examples, to reduce the effects of interference, the first UE 115 may transmit assistance information associated with a timing adjustment for the second UE 115 (e.g., for uplink messages transmitted by the second UE 115).

Some techniques for transmitting assistance information associated with a timing adjustment, as described herein, may provide one or more enhancements to interference mitigation techniques. For example, the first UE 115 may transmit an indication of a value associated with a timing adjustment, such as a timing advance adjustment, for one or more uplink messages (e.g., including uplink data 320) to be transmitted by the second UE 115. In another example, the first UE 115 may transmit an indication of a timing report, where the timing report indicates a difference in timing associated with the first UE 115 receiving the downlink data 310 and timing associated with the first UE 115 receiving the interference associated with the uplink data 320 transmitted by the second UE 115. Additionally, or alternatively, the assistance information may include one or more parameters associated with the downlink data 310, the uplink data 320, or both. For example, the first UE 115 may transmit an indication to increase the frequency range of the guard band 325 (e.g., increase the quantity of guard band 325 symbols) such that the network entity 105 may configure the resource 315-a and the resource 315-b to be separated by a larger guard band 325 to reduce interference. In some other examples, the first UE 115 may transmit an indication to reduce the transmit power for the transmission of the uplink data 320 to reduce the interference.

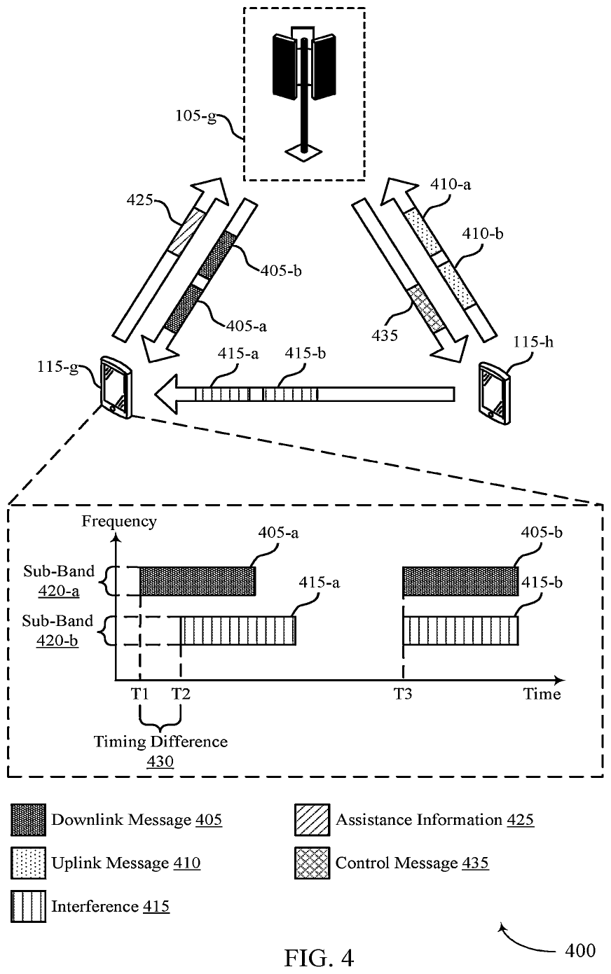

FIG. 4 illustrates an example of a wireless communications system 400 that supports UE indication of preferred timing adjustment in accordance with one or more aspects of the present disclosure. In some examples, the wireless communications system 400 may implement or be implemented by aspects of the wireless communications system 100, the wireless communications system 200, and the full-duplex operation schemes 300. For example, the wireless communications system 400 may be implemented by one or more network entities 105 (e.g., a network entity 105-g) and one or more UEs 115 (e.g., a UE 115-g and a UE 115-h), which may be examples of the corresponding devices as described herein with reference to FIG. 1. In the example of FIG. 4, the network entity 105-g may be an example of a CU 160, a DU 165, an RU 170, a base station 140, an IAB node 104, or one or more other network nodes as described herein with reference to FIG. 1. In some cases, the UE 115-g may transmit, to the network entity 105-g, assistance information associated with a timing adjustment for one or more uplink messages to be transmitted by the UE 115-h.

In some wireless communications systems, a wireless device, such as a user equipment (UE) 115 or a network entity 105, may support wireless communications over one or multiple radio access technologies. In such cases, the wireless device may operate in a half-duplex mode or a full-duplex mode, or a combination thereof, as described herein with reference to FIGS. 2A, 2B, and 2C. In some cases, neighboring wireless devices (e.g., UEs 115, network entities 105, or the like) may perform full-duplex communications or half-duplex TDD concurrently, such that communications, such as downlink messages 405, received by a first UE 115, such as a UE 115-g. may overlap (at least partially) in time with communications, such as uplink messages 410, transmitted by a second UE 115 (e.g., a neighboring UE 115), such as a UE 115-h. In such an example, the uplink communications transmitted by the second UE 115 may interfere with the downlink communications received at the first UE 115, which may be referred to as CLI.

In some cases, the UE 115-g may simultaneously receive interference 415 associated with an uplink message 410 from the UE 115-h and a downlink message 405 from a network entity 105, such as a network entity 105-g. That is, the interference 415 may at least partially overlap in time with the downlink message 405 such that the UE 115-g receives at least a portion of the downlink message 405 at the same time as at least a portion of the interference 415 (e.g., at least a portion of symbols associated with the interference 415 overlap with symbols associated with the downlink message 405). Additionally, a time at which the UE 115-g receives the downlink message 405 (e.g., reception time) may be misaligned with a time at which the UE 115-g receives the interference 415 (e.g., FDM symbols associated with the downlink message 405 are misaligned with FDM symbols associated with the interference 415). That is, a time offset (e.g., time difference 430) may exist between the time at which the UE 115-g receives the downlink message 410 and the time at which the UE 115-g receives the interference 415. In some cases, the misalignment may be due to propagation delay, a TA, or both. For example, the distance between the UE 115-g and the network entity 105-g transmitting the downlink message 405 may be different than a distance between the UE 115-h and the UE 115-g. In such cases, the downlink message 405 may be transmitted at the same time as the interference 415 (e.g., the uplink message 410 associated with the interference 415), however, due to the difference in distance, the UE 115-g may receive the downlink message 405 at a time offset from the interference 415 (e.g., at a different time). In another example, the UE 115-h may transmit the uplink communications (e.g., the uplink message 410) according to a TA. That is, the UE 115-h may receive, from the network entity 105-g, a command (e.g., TA command) indicating that the UE 115-h may transmit the uplink message 410 at a time offset (e.g., a TA) such that one or more uplink messages 410 received at the network entity 105-g (e.g., from multiple UEs 115) are synchronized. In some cases, the time offset (e.g., TA) may be a time offset from a downlink frame (e.g., scheduled downlink frame), such that the network entity 105-g may transmit a downlink message 405 (e.g., during a first frame) and the UE 115-h may transmit an uplink message 410 at an offset from the downlink message 405 (e.g., from the first frame). That is, the time offset may be based on downlink transmission timing of the network entity 105-g and, as such, the time offset may contribute to the misalignment of the interference 415 and downlink message 405 at the first 115-g.

In some cases, misalignment (e.g., a loss of orthogonality) of symbols associated with the downlink message 405 and symbols associated with the interference 415 (e.g., due to misalignment of reception times) may increase energy leakage between resources associated with the downlink message 405 and resources associated with the interference 415, such that the UE 115-g may be unable to perform interference mitigation, resulting in degraded communications at the UE 115-g.

Techniques described herein may support UE 115 indication of a preferred timing adjustment such that a first UE 115, such as the UE 115-g, may align reception of downlink communications, such as downlink messages 405, from a network entity 105, such as the network entity 105-g, and reception of interference, such as interference 415 from a second UE 115, such as the UE 115-h. For example, the network entity 105-g may operate according to a full-duplex communication scheme, such that the network entity 105-g transmits downlink messages 405 to the UE 115-g while simultaneously receiving uplink messages 410 from the UE 115-h. In some cases, the uplink messages 410 transmitted by the UE 115-h may cause interference 415 with the downlink messages 405 at the UE 115-g (as described herein with reference to FIGS. 2A, 2B, and 2C). For example, the UE 115-g may receive a downlink message 405-a and interference 415-a associated with an uplink message 410-a, where the downlink message 405-a at least partially overlaps in time with the interference 415-a. In such cases, the interference 415-a may impact the ability of the UE 115-g to decode the downlink message 405-a (e.g., the interference 415-a may exceed a threshold). For example, the UE 115-g may receive the downlink message 405-a at a time T1 and the interference 415-a at a time T2, such that energy (e.g., frequency) leakage occurs between the sub-band 420-a associated with the downlink message 405-a and the sub-band 420-b associated with the interference 415-a which may result in the UE 115-g being unable to apply interference mitigation to the downlink message 405-a.

As such, the UE 115-g may transmit, to the network entity 105-g, assistance information 425 (e.g., via uplink control signaling) associated with a timing adjustment based on the interference 415-a, where the timing adjustment is associated with additional uplink messages 410 to be transmitted by the UE 115-h, such as an uplink message 410-b. That is, the UE 115-g may transmit the assistance information 425 to enable the network entity 105-g to adjust transmission timing associated with additional downlink messages 405, such as a downlink message 405-b, a TA associated with the additional uplink messages 410, such as an uplink message 410-b, or both, such that the UE 115-g receives the downlink message 405-b and interference 415-b associated with the uplink message 410-b at the same time. In other words, the UE 115-g may transmit the assistance information 425 to enable the network entity 105-g to adjust transmission timing associated with additional downlink messages 405 so that reception of the uplink message 410-b by the UE 115-g is aligned with reception of the interference 415-b (e.g., a timing difference 430 between the downlink message 405-b and the interference 415-b is less than or equal to a threshold).

In some cases, the UE 115-g may measure the interference 415-a and transmit the assistance information 425 based on the interference 415 exceeding a threshold. In some cases, the UE 115-g may receive control signaling from the network entity 105-g indicating the threshold. In some other cases, the threshold may be based on one or more parameters at the UE 115-g (e.g., pre-configured at the UE 115-g).

In some cases, the assistance information 425 may include an indication of a TA adjustment for the UE 115-h. For example, the UE 115-g may compare the time T1 associated with reception of the downlink message 405-a to time T2 associated with reception of the interference 415-a to determine a timing difference 430. As such, the UE 115-g may determine a TA adjustment for the UE 115-h based on the timing difference 430 and may transmit an indication of the TA adjustment in the assistance information 425. Additionally, or alternatively, the assistance information 425 may include an indication of the timing difference 430. That is, the UE 115-g may transmit an indication of the time T2 (e.g., reception timing of the interference 415-a) relative to time T1 (e.g., a difference between reception timing from the network entity 105-g and the UE 115-h).

In some other cases, the assistance information 425 may include an indication of one or more parameters associated with the timing adjustment. For example, the UE 115-g may transmit an indication of a guard band (as described with respect to FIG. 3A), one or more guard symbols, a power control parameter (e.g., transmit power), or any combination thereof. The one or more parameters (if applied) may result in decreased interference 415 at the UE 115-g.

In some examples, the network entity 105-g may determine to apply a timing adjustment to the uplink messages 410 transmitted from the UE 115-h based on the assistance information 425. For example, the UE 115-g may transmit a control message 435 to the UE 115-h indicating a TA for the uplink message 410-b (e.g., and future uplink messages 410). That is, the uplink message 410-a may be transmitted according to a first TA and the uplink message 410-b may be transmitted according to a second TA, where the second TA is indicated in the control message 435 and is based on the assistance information 425. In other words, the network entity 105-g may adjust the TA of the uplink message 410-b such that the UE 115-g receives the interference 415-b associated with the uplink message 410-b at a time T3. In such cases, the UE 115-g may receive the downlink message 405-b and the interference 415-b (associated with the uplink message 410-b) at the time T3, such that the downlink message 405-b and the interference 415-b are in alignment (e.g., symbols associated with the downlink message 405-b are aligned with symbols associated with the interference 415-b), reducing the impacts of the interference 415-b. That is, a time at which the UE 115-g receives the downlink message 405-b and the interference 415-b may be the same (e.g., or less than a threshold).

In some cases, the network entity 105-g may determine not to apply a timing adjustment to the uplink message 410-b transmitted from the UE 115-h (e.g., based on impacts to timing of the uplink message 410-b). For example, the timing difference 430 may exceed a threshold and applying a timing adjustment associated with the timing difference 430 may result in loss of synchronization of uplink messages 410 received from multiple UEs 115 at the network entity 105-g, which may impact the ability of the network entity 105-g to receive or decode the uplink message 410-b.

In some cases, the network entity 105-g may apply a timing adjustment to transmission of the downlink message 405-b. For example, the network entity 105-g may adjust a time at which the network entity 105-g transmits the downlink message 405-b (in relation to the uplink message 410-b). In other words, the network entity 105-g may adjust a transmission timing of the downlink message 405-b such that the UE 115-g receives the downlink message 405-b at the time T3. In such cases, the UE 115-g may receive the downlink message 405-b and the interference 415-b at a time T3, such that the downlink message 405-b and the interference 415-b are in alignment.

While much of the present disclosure is described in the context of a network entity 105, such as the network entity 105-g, operating in a full-duplex mode this is not to be regarded as a limitation of the present disclosure. Indeed, it is contemplated herein that the network entity 105-g may transmit downlink messages 405 to the UE 115-g and receive uplink messages 410 from the UE 115-h, resulting in interference 415. In this regard, a system including two network entities 105 each communicating with one of the UE 115-g and the UE 115-f, may be considered with regards to the techniques described herein. That is, the UE 115-g may receive the downlink message 405-a from a first network entity 105 and the UE 115-h may transmit the uplink message 410-a to a second network entity 105, resulting in the UE 115-g receiving the interference 415-a that at least partially overlaps in time with the downlink message 405-a. In such cases, the UE 115-f may transmit assistance information associate with a timing adjustment based on the interference 415-a, where the timing adjustment is associated with one more uplink messages 410 to be transmitted by the UE 115-h to the second network entity 105. In some cases, the first network entity 105 may adjust a transmission time of additional downlink messages 405 based on the assistance information. In some other cases, the first network entity 105 may transmit the assistance information to the second network entity 105, such that the second network entity 105 may determine to apply the timing adjustment to the UE 115-h.

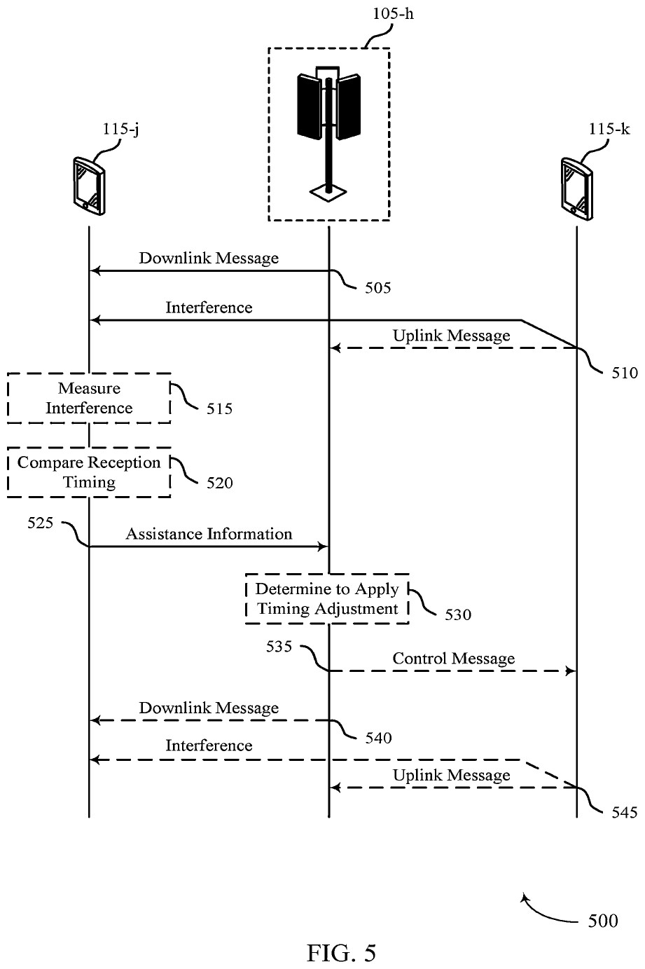

FIG. 5 illustrates an example of a process flow 500 that supports UE indication of preferred timing adjustment in accordance with one or more aspects of the present disclosure. In some examples, the process flow 500 may implement or be implemented by aspects of the wireless communications system 100, the wireless communications system 200, the full-duplex operation schemes 300, and the wireless communications system 400. For example, the process flow 500 may be implemented by one or more network entities 105 (e.g., a network entity 105-h) and one or more UEs 115 (e.g., a UE 115-j and a UE 115-k), which may be examples of the corresponding devices as described herein with reference to FIG. 1. In the example of FIG. 5, the network entity 105-h may be an example of a CU 160, a DU 165, an RU 170, a base station 140, an IAB node 104, or one or more other network nodes as described herein with reference to FIG. 1. In some cases, the UE 115-j may transmit, to the network entity 105-h (operating in a full-duplex mode), assistance information associated with a timing adjustment for one or more uplink messages to be transmitted by the UE 115-k.

At 505, the UE 115-j may receive, from the network entity 105-h, a downlink message. In some cases, the downlink message may be associated with a first transmission timing. Additionally, or alternatively, the downlink message may be associated with a first sub-band.

At 510, the UE 115-k may transmit, to the network entity 105-h, an uplink message and the uplink message may cause interference at the UE 115-j, such that the UE 115-j receives a first level of interference. The first level of interference may be based on the uplink message transmitted from the UE 115-k and may at least partially overlaps in time with the downlink message. Additionally, or alternatively, the uplink message may be associated with a second sub-band.

In some cases, at 515, the UE 115-j may measure the first level of interference and compare the first level of interference to a threshold. In some cases, the UE 115-j may receive, from the network entity 105-h, control signaling including an indication of the threshold. In some other cases, the threshold may be based on one or more parameters at the UE 115-j (e.g., pre-configured at the UE 115-j).

In some cases, at 520, the UE 115-j may compare timing associated with reception of the downlink message to timing associated with reception of the first level of interference.

At 525, the UE 115-j may transmit, to the network entity 1105-h, assistance information associated with a timing adjustment based on the first level of interference (e.g., based on the first level of interference exceeding the threshold), where the timing adjustment is associated with one or more uplink messages to be transmitted from the UE 115-k. In some cases, the assistance information may include an indication of a value associated with a timing adjustment for the UE 115-k. Additionally, or alternatively, the assistance information may include an indication of a timing report, where the timing report includes an indication of a difference between the timing associated with the reception of the downlink message and the timing associated with the reception of the first level of interference. In some cases, the assistance information may include an indication of one or more parameters associated with the downlink message, the uplink message, or both. For example, the parameters may be associated with one or more guard bands, one or more guard symbols, one or more power control parameters, or any combination thereof.

In some cases, the UE 115-j may transmit the assistance information based on the difference between the timing associated with the reception of the downlink message and the timing associated with the reception of the first level of interference exceeding a threshold. That is, a time offset between the reception of the downlink message and the reception of the first level of interference may exceed the threshold.

In some cases, at 530, the network entity 105-h may determine whether to apply the timing adjustment to the UE 115-k. In some cases, the network entity 105-h may apply the timing adjustment to the UE 115-k based on a value associated with the timing adjustment, where determining to apply the timing adjustment is based on the value being less than or equal to a threshold. That is, if the value associated with the timing adjustment is greater than the threshold, the network entity 105-h may determine not to apply the timing adjustment to the UE 115-k due to potential negative impacts to timing of additional uplink messages (e.g., if the timing adjustment is too large, the network entity 105-h may not be able to receive or decode the additional uplink messages).

In some cases, at 535, the network entity 105-h may transmit, to the UE 115-k, a control message indicating a second timing advance, where the second timing advance is based on the value associated with the timing adjustment.

In some cases, at 540, the network entity 105-h may transmit a second downlink message to the UE 115-j. In some cases, the second downlink message may be associated with a second transmission timing, where the second transmission timing is based on the assistance information. That is, the network entity 105-h may adjust the transmission timing of downlink messages from first transmission timing to the second transmission timing based on the assistance information such that reception of the second downlink message aligns with reception of a second level of interference associated with a second uplink message. In some cases, the UE 115-j may receive, from the network entity 105-h, a control message indicating the second transmission timing.

In some cases, at 545, the UE 115-k may transmit, to the network entity 105-h, the second uplink message according to a second timing advance and the second uplink message may cause interference at the UE 115-j, such that the UE 115-j receives the second level of interference, where the second level of interference is based on the assistance information. In some cases, the second level of interference may be less than the threshold. Additionally, a difference between timing associated with the reception of the second downlink message and timing associated with the reception of the second level of interference may be below a threshold (e.g., reception of the second downlink message and reception of the second level of interference may be in alignment).

In some case, the UE 115-j may receive, from the network entity 105-h, a feedback message indicating whether the network entity 105-h applied the timing adjustment to the UE 115-k.

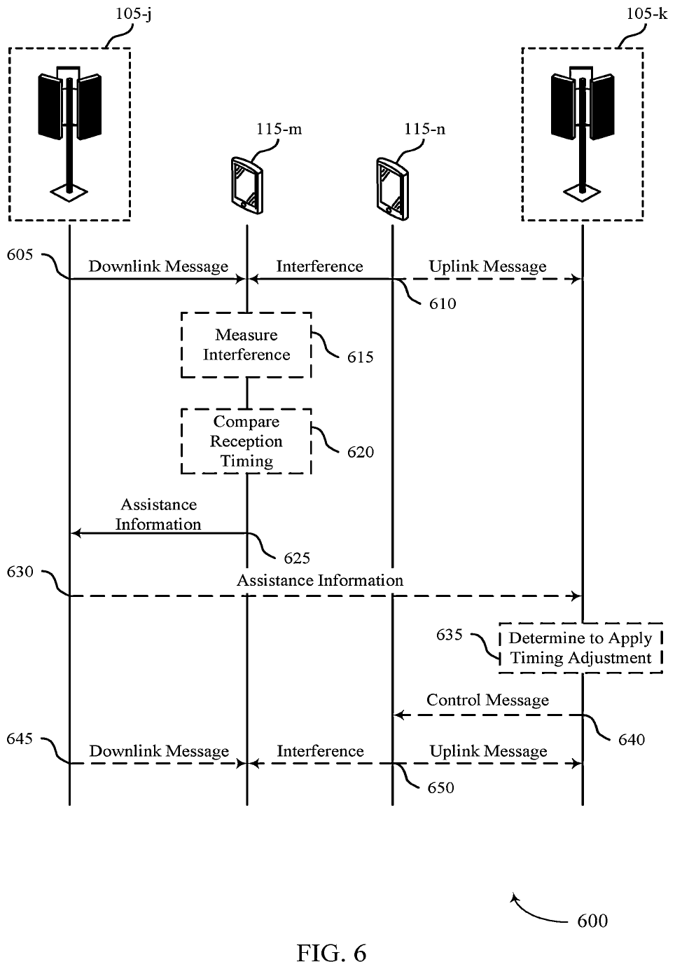

FIG. 6 illustrates an example of a process flow 600 that supports UE indication of preferred timing adjustment in accordance with one or more aspects of the present disclosure. In some examples, the process flow 600 may implement or be implemented by aspects of the wireless communications system 100, the wireless communications system 200, the full-duplex operation schemes 300, and the wireless communications system 400. For example, the process flow 600 may be implemented by one or more network entities 105 (e.g., a network entity 105-j and a network entity 105-k) and one or more UEs 115 (e.g., a UE 115-m and a UE 115-n), which may be examples of the corresponding devices as described herein with reference to FIG. 1. In the example of FIG. 6, the network entity 105-h may be an example of a CU 160, a DU 165, an RU 170, a base station 140, an IAB node 104, or one or more other network nodes as described herein with reference to FIG. 1. In some cases, the UE 115-m may transmit, to the network entity 105-j, assistance information associated with a timing adjustment for one or more uplink messages to be transmitted by the UE 115-n and the network entity 105-j may forward the assistance information to the network entity 105-k via a backhaul communications link.

At 605, the UE 115-m may receive, from the network entity 105-j, a downlink message. In some cases, the downlink message may be associated with a first transmission timing. Additionally, or alternatively, the downlink message may be associated with a first sub-band.

At 610, the UE 115-n may transmit, to the network entity 105-k, an uplink message and the uplink message may cause interference at the UE 115-m, such that the UE 115-m receives a first level of interference. The first level of interference may be based on the uplink message transmitted from the UE 115-n and may at least partially overlaps in time with the downlink message. Additionally, or alternatively, the uplink message may be associated with a second sub-band.

In some cases, at 615, the UE 115-m may measure the first level of interference and compare the first level of interference to a threshold. In some cases, the UE 115-m may receive, from the network entity 105-h, control signaling including an indication of the threshold. In some other cases, the threshold may be based on one or more parameters at the UE 115-m (e.g., pre-configured at the UE 115-m).

In some cases, at 620, the UE 115-j may compare timing associated with reception of the downlink message to timing associated with reception of the first level of interference.

At 625, the UE 115-j may transmit, to the network entity 105-j, assistance information associated with a timing adjustment based on the first level of interference (e.g., based on the first level of interference exceeding the threshold), where the timing adjustment is associated with one or more uplink messages to be transmitted from the UE 115-n. In some cases, the assistance information may include an indication of a value associated with a timing adjustment for the UE 115-n. Additionally, or alternatively, the assistance information may include an indication of a timing report, where the timing report includes an indication of a difference between the timing associated with the reception of the downlink message and the timing associated with the reception of the first level of interference. In some cases, the assistance information may include an indication of one or more parameters associated with the downlink message, the uplink message, or both. For example, the parameters may be associated with one or more guard bands, one or more guard symbols, one or more power control parameters, or any combination thereof.

In some cases, the UE 115-j may transmit the assistance information based on the difference between the timing associated with the reception of the downlink message and the timing associated with the reception of the first level of interference exceeding a threshold.

In some cases, at 630, the network entity 105-j may transmit, to the network entity 105-k, the assistance information associated with the timing adjustment.

In some cases, at 635, the network entity 105-k may determine whether to apply the timing adjustment to the UE 115-n. In some cases, the network entity 105-k may apply the timing adjustment to the UE 115-n based on a value associated with the timing adjustment, where determining to apply the timing adjustment is based on the value being less than or equal to a threshold (e.g., if the timing adjustment is too large, the network entity 105-h may not be able to receive or decode the additional uplink messages).

In some cases, at 640, the network entity 105-k may transmit, to the UE 115-n, a control message indicating a second timing advance, where the second timing advance is based on the value associated with the timing adjustment.

In some cases, at 645, the network entity 105-j may transmit a second downlink message to the UE 115-m. In some cases, the second downlink message may be associated with a second transmission timing, where the second transmission timing is based on the assistance information. That is, the network entity 105-j may adjust the transmission timing of downlink messages from first transmission timing to the second transmission timing based on the assistance information such that reception of the second downlink message aligns with reception of a second level of interference associated with a second uplink message. In some cases, the UE 115-m may receive, from the network entity 105-j, a control message indicating the second transmission timing.

In some cases, at 650, the UE 115-n may transmit, to the network entity 105-k, the second uplink message according to a second timing advance and the second uplink message may cause interference at the UE 115-m, such that the UE 115-m receives the second level of interference, where the second level of interference is based on the assistance information. In some cases, the second level of interference may be less than the threshold. Additionally, a difference between timing associated with the reception of the second downlink message and timing associated with the reception of the second level of interference may be below a threshold (e.g., reception of the second downlink message and reception of the second level of interference may be in alignment).

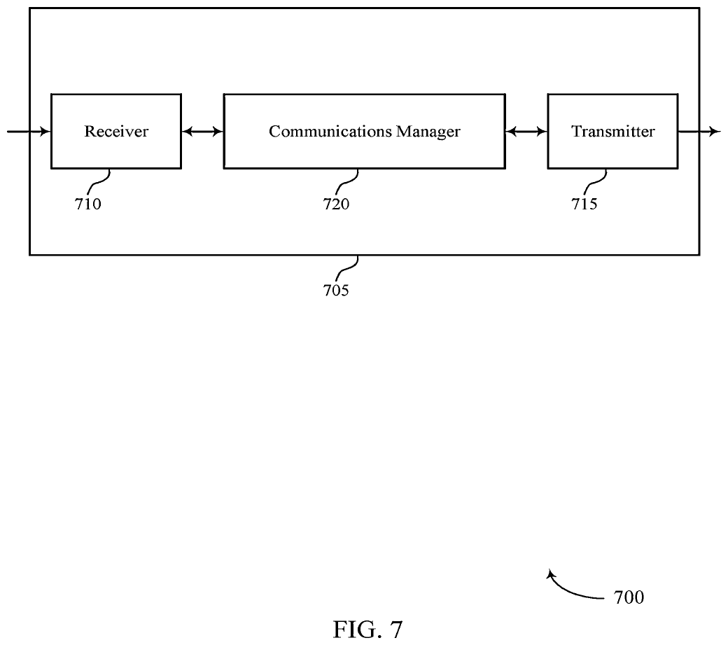

FIG. 7 shows a block diagram 700 of a device 705 that supports UE indication of preferred timing adjustment in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to UE indication of preferred timing adjustment). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to UE indication of preferred timing adjustment). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of UE indication of preferred timing adjustment as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a first UE in accordance with examples as disclosed herein. For example, the communications manager 720 may be configured as or otherwise support a means for receiving, from a network entity, a downlink message at the first UE. The communications manager 720 may be configured as or otherwise support a means for receiving a first level of interference at the first UE, where the first level of interference is based at least in part on an uplink message transmitted from a second UE and where the first level of interference at least partially overlaps in time with the downlink message. The communications manager 720 may be configured as or otherwise support a means for transmitting, to the network entity, assistance information associated with a timing adjustment based at least in part on the first level of interference, where the timing adjustment is associated with one or more uplink messages to be transmitted from the second UE.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for transmitting assistance information associated with a preferred timing adjustment which may result in reduced processing, reduced power consumption, and more efficient utilization of communication resources, among other advantages.

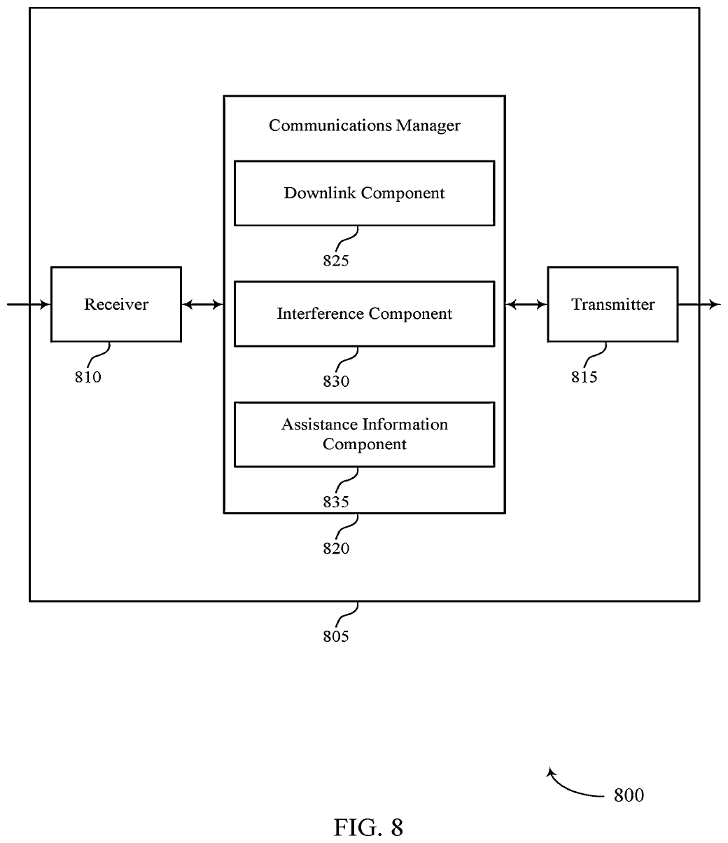

FIG. 8 shows a block diagram 800 of a device 805 that supports UE indication of preferred timing adjustment in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to UE indication of preferred timing adjustment). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to UE indication of preferred timing adjustment). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of UE indication of preferred timing adjustment as described herein. For example, the communications manager 820 may include a downlink component 825, an interference component 830, an assistance information component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a first UE in accordance with examples as disclosed herein. The downlink component 825 may be configured as or otherwise support a means for receiving, from a network entity, a downlink message at the first UE. The interference component 830 may be configured as or otherwise support a means for receiving a first level of interference at the first UE, where the first level of interference is based at least in part on an uplink message transmitted from a second UE and where the first level of interference at least partially overlaps in time with the downlink message. The assistance information component 835 may be configured as or otherwise support a means for transmitting, to the network entity, assistance information associated with a timing adjustment based at least in part on the first level of interference, where the timing adjustment is associated with one or more uplink messages to be transmitted from the second UE.

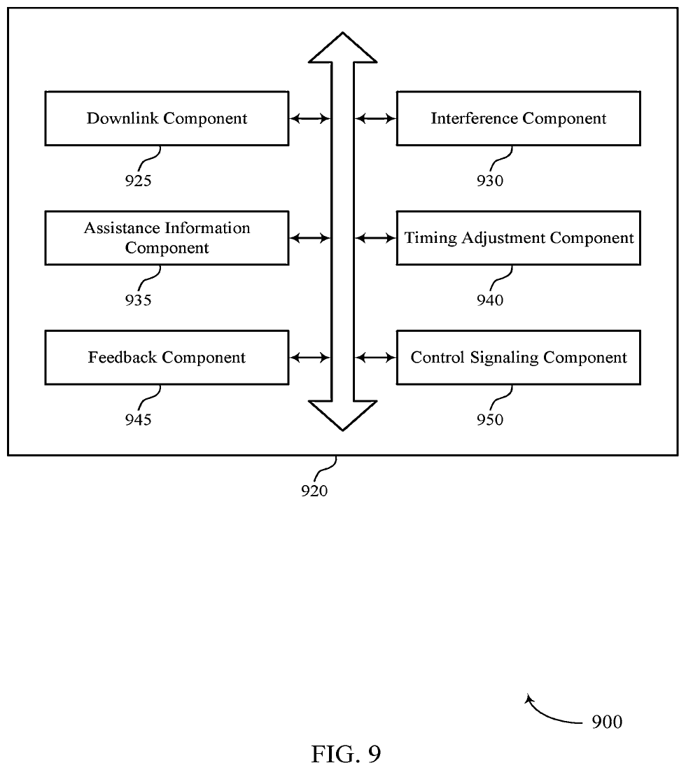

FIG. 9 shows a block diagram 900 of a communications manager 920 that supports UE indication of preferred timing adjustment in accordance with one or more aspects of the present disclosure. The communications manager 920 may be an example of aspects of a communications manager 720, a communications manager 820, or both, as described herein. The communications manager 920, or various components thereof, may be an example of means for performing various aspects of UE indication of preferred timing adjustment as described herein. For example, the communications manager 920 may include a downlink component 925, an interference component 930, an assistance information component 935, a timing adjustment component 940, a feedback component 945, a control signaling component 950, or any combination thereof. Each of these components may communicate, directly or indirectly, with one another (e.g., via one or more buses).

The communications manager 920 may support wireless communications at a first UE in accordance with examples as disclosed herein. The downlink component 925 may be configured as or otherwise support a means for receiving, from a network entity, a downlink message at the first UE. The interference component 930 may be configured as or otherwise support a means for receiving a first level of interference at the first UE, where the first level of interference is based at least in part on an uplink message transmitted from a second UE and where the first level of interference at least partially overlaps in time with the downlink message. The assistance information component 935 may be configured as or otherwise support a means for transmitting, to the network entity, assistance information associated with a timing adjustment based at least in part on the first level of interference, where the timing adjustment is associated with one or more uplink messages to be transmitted from the second UE.

In some examples, the timing adjustment component 940 may be configured as or otherwise support a means for comparing timing associated with reception of the downlink message to timing associated with reception of the first level of interference, where the assistance information is based at least in part on the comparison.

In some examples, to support transmitting the assistance information, the timing adjustment component 940 may be configured as or otherwise support a means for transmitting an indication of a value associated with the timing adjustment for the second UE, where the value associated with the timing adjustment is based at least in part on the comparison.

In some examples, to support transmitting the assistance information, the timing adjustment component 940 may be configured as or otherwise support a means for transmitting an indication of a timing report, where the timing report includes an indication of a difference between the timing associated with the reception of the downlink message and the timing associated with the reception of the first level of interference based at least in part on the comparison.

In some examples, to support transmitting the assistance information, the assistance information component 935 may be configured as or otherwise support a means for transmitting, to the network entity, the assistance information associated with the timing adjustment based at least in part on a difference between the timing associated with the reception of the downlink message and the timing associated with the reception of the first level of interference exceeding a threshold, where the difference is based at least in part on the comparison.

In some examples, the interference component 930 may be configured as or otherwise support a means for measuring the first level of interference, where transmitting the assistance information is based at least in part on the first level of interference exceeding a threshold.

In some examples, the control signaling component 950 may be configured as or otherwise support a means for receiving, from the network entity, control signaling including an indication of the threshold.

In some examples, the threshold is based at least in part on one or more parameters at the first UE.

In some examples, to support transmitting the assistance information, the assistance information component 935 may be configured as or otherwise support a means for transmitting an indication of one or more parameters associated with the downlink message, the uplink message, or both, where the assistance information includes the one or more parameters.

In some examples, the one or more parameters are associated with one or more guard bands, one or more guard symbols, one or more power control parameters, or any combination thereof.

In some examples, the downlink component 925 may be configured as or otherwise support a means for receiving, from the network entity, a second downlink message at the first UE. In some examples, the interference component 930 may be configured as or otherwise support a means for receiving a second level of interference at the first UE based at least in part on the one or more uplink messages transmitted from the second UE, where the second level of interference is based at least in part on the assistance information.

In some examples, the second level of interference is less than a threshold.

In some examples, the downlink message is associated with a first TA and, to support receiving the second downlink message, the downlink component 925 may be configured as or otherwise support a means for receiving the second downlink message associated with a second transmission timing, where the second transmission timing is based at least in part on the assistance information.

In some examples, the control signaling component 950 may be configured as or otherwise support a means for receiving, from the network entity, a control message indicating the second transmission timing, where receiving the second downlink message is based at least in part on the control message.

In some examples, a difference between timing associated with the reception of the second downlink message and timing associated with the reception of the second level of interference is below a threshold.

In some examples, the downlink message is associated with a first sub-band and the uplink message is associated with a second sub-band.

In some examples, the feedback component 945 may be configured as or otherwise support a means for receiving, from the network entity, a feedback message indicating whether the network entity applied the timing adjustment to the second UE based at least in part on receiving the assistance information.

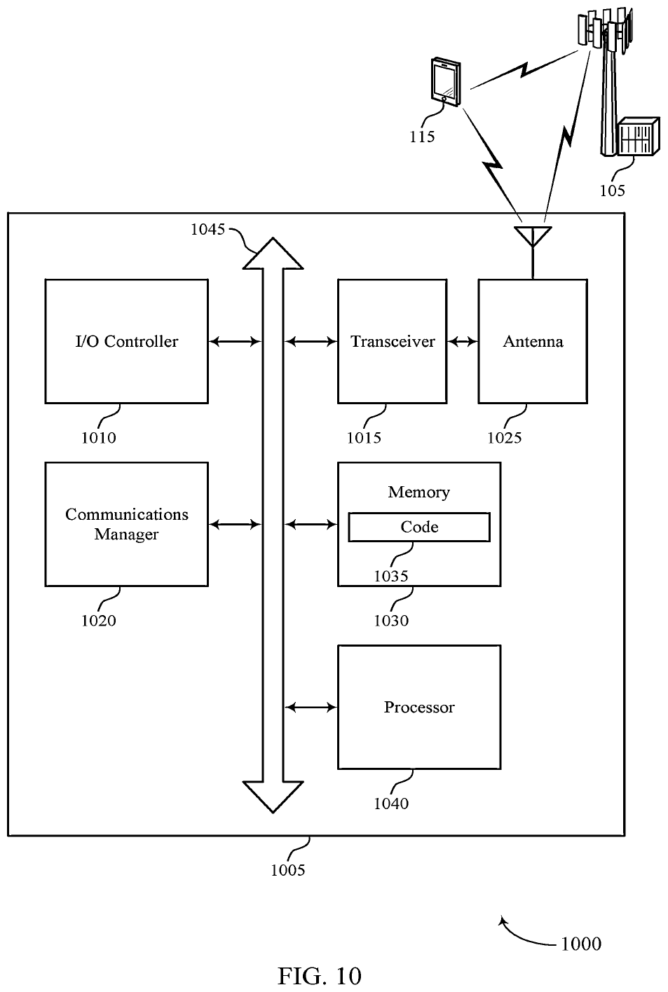

FIG. 10 shows a diagram of a system 1000 including a device 1005 that supports UE indication of preferred timing adjustment in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting UE indication of preferred timing adjustment). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a first UE in accordance with examples as disclosed herein. For example, the communications manager 1020 may be configured as or otherwise support a means for receiving, from a network entity, a downlink message at the first UE. The communications manager 1020 may be configured as or otherwise support a means for receiving a first level of interference at the first UE, where the first level of interference is based at least in part on an uplink message transmitted from a second UE and where the first level of interference at least partially overlaps in time with the downlink message. The communications manager 1020 may be configured as or otherwise support a means for transmitting, to the network entity, assistance information associated with a timing adjustment based at least in part on the first level of interference, where the timing adjustment is associated with one or more uplink messages to be transmitted from the second UE.

By including or configuring the communications manager 1020 in accordance with examples as described herein, the device 1005 may support techniques for transmitting assistance information associated with a preferred timing adjustment which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described herein with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of UE indication of preferred timing adjustment as described herein, or the processor 1040 and the memory 1030 may be otherwise configured to perform or support such operations.

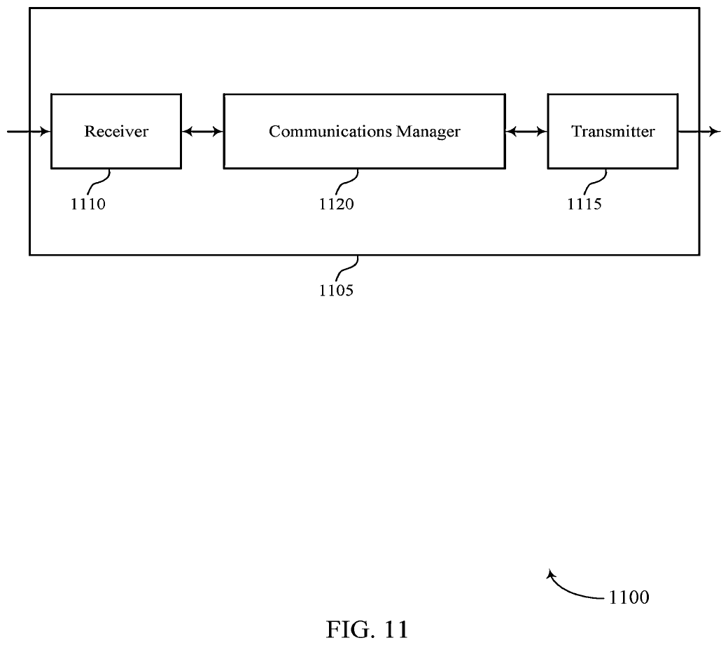

FIG. 11 shows a block diagram 1100 of a device 1105 that supports UE indication of preferred timing adjustment in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of UE indication of preferred timing adjustment as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 may be configured as or otherwise support a means for transmitting, to a first UE, a downlink message, where a first level of interference is associated with the downlink message, the first level of interference based at least in part on an uplink message transmitted from a second UE. The communications manager 1120 may be configured as or otherwise support a means for receiving assistance information associated with a timing adjustment based at least in part on the first level of interference, where the timing adjustment is associated with one or more uplink message to be transmitted from the second UE.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for transmitting assistance information associated with a preferred timing adjustment which may result in reduced processing, reduced power consumption, and more efficient utilization of communication resources, among other advantages.

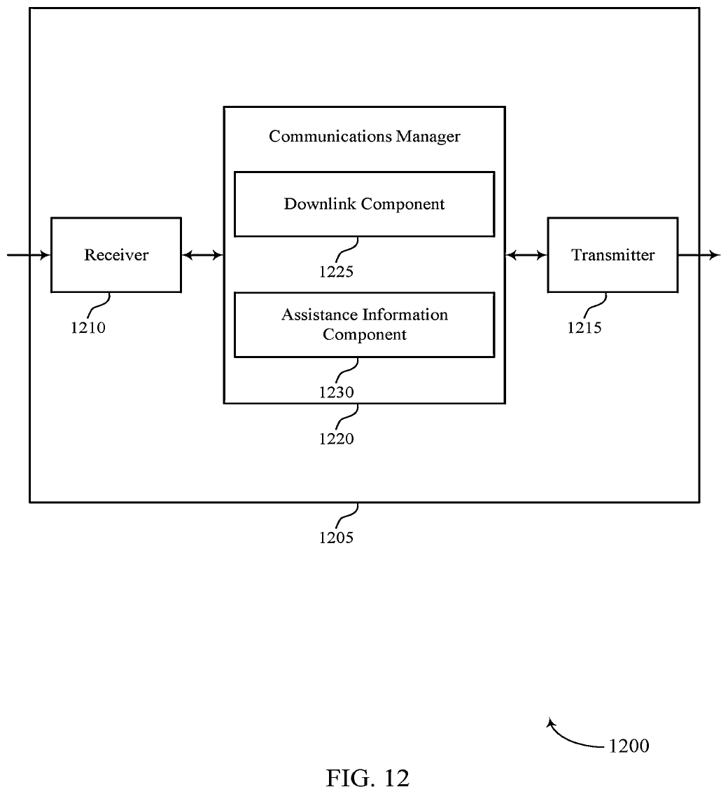

FIG. 12 shows a block diagram 1200 of a device 1205 that supports UE indication of preferred timing adjustment in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of UE indication of preferred timing adjustment as described herein. For example, the communications manager 1220 may include a downlink component 1225 an assistance information component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The downlink component 1225 may be configured as or otherwise support a means for transmitting, to a first UE, a downlink message, where a first level of interference is associated with the downlink message, the first level of interference based at least in part on an uplink message transmitted from a second UE. The assistance information component 1230 may be configured as or otherwise support a means for receiving assistance information associated with a timing adjustment based at least in part on the first level of interference, where the timing adjustment is associated with one or more uplink message to be transmitted from the second UE.

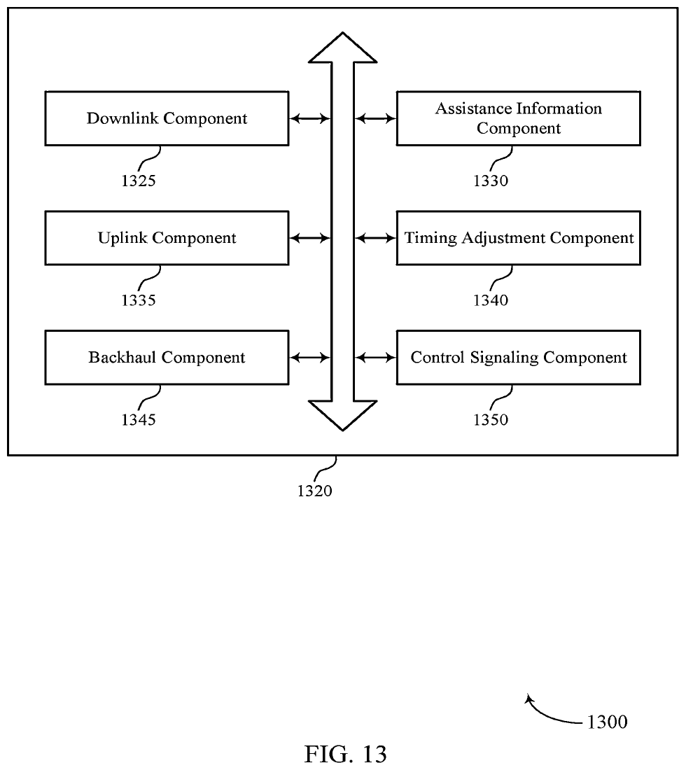

FIG. 13 shows a block diagram 1300 of a communications manager 1320 that supports UE indication of preferred timing adjustment in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of UE indication of preferred timing adjustment as described herein. For example, the communications manager 1320 may include a downlink component 1325, an assistance information component 1330, an uplink component 1335, a timing adjustment component 1340, a backhaul component 1345, a control signaling component 1350, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The downlink component 1325 may be configured as or otherwise support a means for transmitting, to a first UE, a downlink message, where a first level of interference is associated with the downlink message, the first level of interference based at least in part on an uplink message transmitted from a second UE. The assistance information component 1330 may be configured as or otherwise support a means for receiving assistance information associated with a timing adjustment based at least in part on the first level of interference, where the timing adjustment is associated with one or more uplink message to be transmitted from the second UE.

In some examples, the uplink component 1335 may be configured as or otherwise support a means for receiving the uplink message from the second UE according to a first TA. In some examples, the timing adjustment component 1340 may be configured as or otherwise support a means for determining whether to apply the timing adjustment to the second UE, where the timing adjustment is based at least in part on the assistance information.

In some examples, the timing adjustment component 1340 may be configured as or otherwise support a means for applying the timing adjustment to the second UE based at least in part on a value associated with the timing adjustment, where determining to apply the timing adjustment is based at least in part on the value being less than or equal to a threshold.

In some examples, to support applying the timing adjustment, the control signaling component 1350 may be configured as or otherwise support a means for transmitting, to the second UE, a control message indicating a second TA, where the second TA is based at least in part on the value associated with the timing adjustment. In some examples, to support applying the timing adjustment, the uplink component 1335 may be configured as or otherwise support a means for receiving a second uplink message from the second UE according to the second TA.

In some examples, the downlink message is associated with a first transmission timing, and the downlink component 1325 may be configured as or otherwise support a means for transmitting a second downlink message according to a second transmission timing, where the second transmission timing is based at least in part on a value associated with the timing adjustment.

In some examples, to support receiving the assistance information, the assistance information component 1330 may be configured as or otherwise support a means for receiving an indication of a value associated with the timing adjustment for the second UE, where the assistance information includes the indication.

In some examples, to support receiving the assistance information, the assistance information component 1330 may be configured as or otherwise support a means for receiving an indication of a timing report, where the timing report includes an indication of a difference between timing associated with reception of the downlink message by the first UE and timing associated with reception of the first level of interference by the first UE, where the assistance information includes the timing report.

In some examples, to support receiving the assistance information, the assistance information component 1330 may be configured as or otherwise support a means for receiving an indication of one or more parameters associated with the downlink message, the uplink message, or both, where the assistance information includes the one or more parameters.

In some examples, the one or more parameters are associated with one or more guard bands, one or more guard symbols, one or more power control parameters, or any combination thereof.

In some examples, the backhaul component 1345 may be configured as or otherwise support a means for transmit, to a second network entity, the assistance information associated with the timing adjustment, where the second network entity is associated with the uplink message.

In some examples, the first level of interference exceeds a threshold.

In some examples, the downlink message is associated with a first sub-band and the uplink message is associated with a second sub-band.

In some examples, the control signaling component 1350 may be configured as or otherwise support a means for transmitting, to the first UE, a control message including an indication of a threshold associated with interference at the first UE.

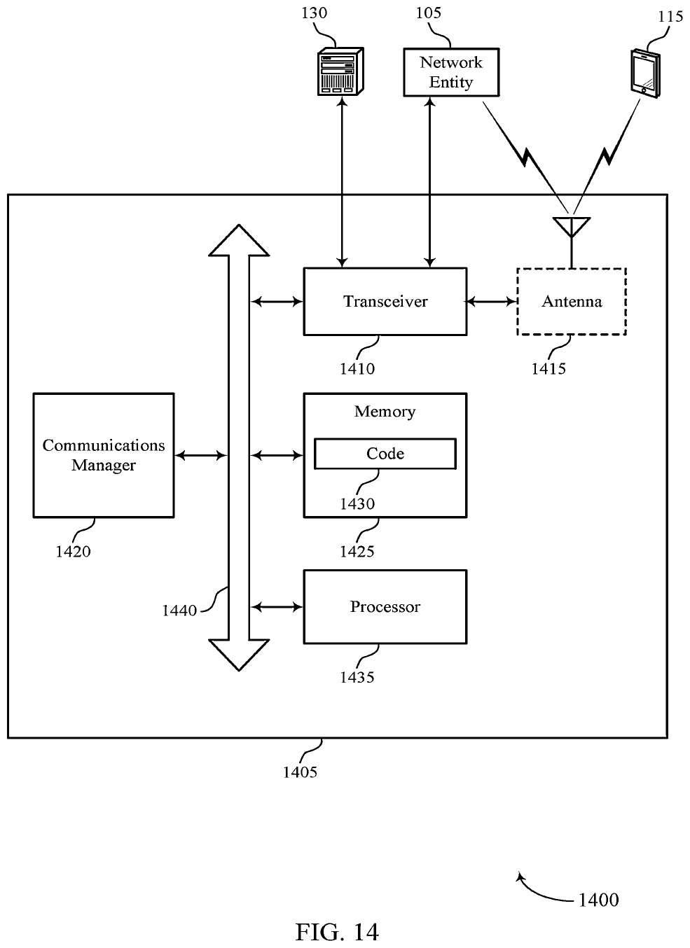

FIG. 14 shows a diagram of a system 1400 including a device 1405 that supports UE indication of preferred timing adjustment in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting UE indication of preferred timing adjustment). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 may be configured as or otherwise support a means for transmitting, to a first UE, a downlink message, where a first level of interference is associated with the downlink message, the first level of interference based at least in part on an uplink message transmitted from a second UE. The communications manager 1420 may be configured as or otherwise support a means for receiving assistance information associated with a timing adjustment based at least in part on the first level of interference, where the timing adjustment is associated with one or more uplink message to be transmitted from the second UE.

By including or configuring the communications manager 1420 in accordance with examples as described herein, the device 1405 may support techniques for transmitting assistance information associated with a preferred timing adjustment which may result in improved communication reliability, reduced latency, improved user experience related to reduced processing, reduced power consumption, more efficient utilization of communication resources, improved coordination between devices, longer battery life, and improved utilization of processing capability, among other advantages.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described herein with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of UE indication of preferred timing adjustment as described herein, or the processor 1435 and the memory 1425 may be otherwise configured to perform or support such operations.

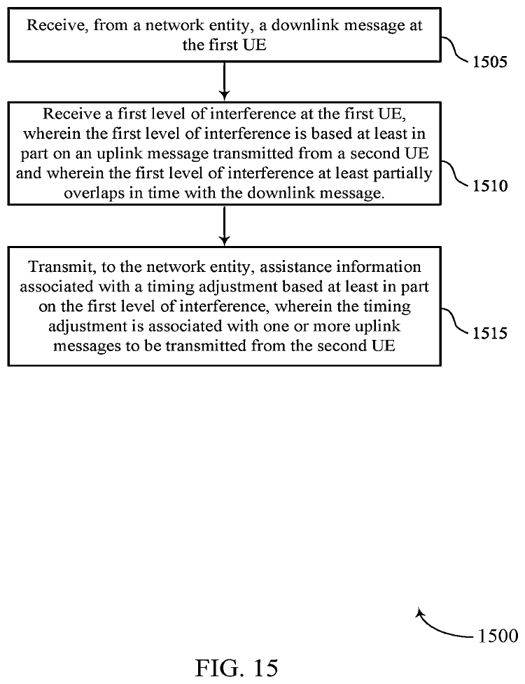

FIG. 15 shows a flowchart illustrating a method 1500 that supports UE indication of preferred timing adjustment in accordance with one or more aspects of the present disclosure. The operations of the method 1500 may be implemented by a UE or its components as described herein. For example, the operations of the method 1500 may be performed by a UE 115 as described herein with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a downlink message at the first UE. The operations of 1505 may be performed in accordance with examples as disclosed herein. In some examples, aspects of the operations of 1505 may be performed by a downlink component 925 as described herein with reference to FIG. 9.

At 1510, the method may include receiving a first level of interference at the first UE, where the first level of interference is based at least in part on an uplink message transmitted from a second UE and where the first level of interference at least partially overlaps in time with the downlink message. The operations of 1510 may be performed in accordance with examples as disclosed herein. In some examples, aspects of the operations of 1510 may be performed by an interference component 930 as described herein with reference to FIG. 9.

At 1515, the method may include transmitting, to the network entity, assistance information associated with a timing adjustment based at least in part on the first level of interference, where the timing adjustment is associated with one or more uplink messages to be transmitted from the second UE. The operations of 1515 may be performed in accordance with examples as disclosed herein. In some examples, aspects of the operations of 1515 may be performed by an assistance information component 935 as described herein with reference to FIG. 9.

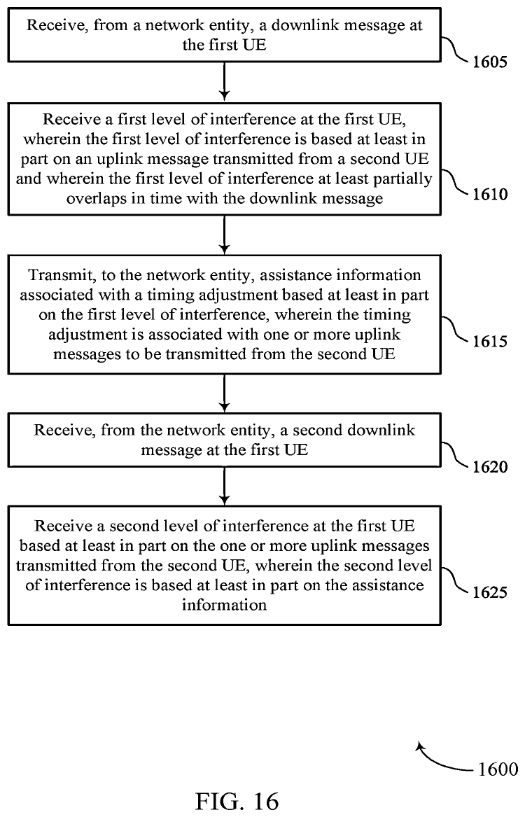

FIG. 16 shows a flowchart illustrating a method 1600 that supports UE indication of preferred timing adjustment in accordance with one or more aspects of the present disclosure. The operations of the method 1600 may be implemented by a UE or its components as described herein. For example, the operations of the method 1600 may be performed by a UE 115 as described herein with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, a downlink message at the first UE. The operations of 1605 may be performed in accordance with examples as disclosed herein. In some examples, aspects of the operations of 1605 may be performed by a downlink component 925 as described herein with reference to FIG. 9.

At 1610, the method may include receiving a first level of interference at the first UE, where the first level of interference is based at least in part on an uplink message transmitted from a second UE and where the first level of interference at least partially overlaps in time with the downlink message. The operations of 1610 may be performed in accordance with examples as disclosed herein. In some examples, aspects of the operations of 1610 may be performed by an interference component 930 as described herein with reference to FIG. 9.

At 1615, the method may include transmitting, to the network entity, assistance information associated with a timing adjustment based at least in part on the first level of interference, where the timing adjustment is associated with one or more uplink messages to be transmitted from the second UE. The operations of 1615 may be performed in accordance with examples as disclosed herein. In some examples, aspects of the operations of 1615 may be performed by an assistance information component 935 as described herein with reference to FIG. 9.

At 1620, the method may include receiving, from the network entity, a second downlink message at the first UE. The operations of 1620 may be performed in accordance with examples as disclosed herein. In some examples, aspects of the operations of 1620 may be performed by a downlink component 925 as described herein with reference to FIG. 9.

At 1625, the method may include receiving a second level of interference at the first UE based at least in part on the one or more uplink messages transmitted from the second UE, where the second level of interference is based at least in part on the assistance information. The operations of 1625 may be performed in accordance with examples as disclosed herein. In some examples, aspects of the operations of 1625 may be performed by an interference component 930 as described herein with reference to FIG. 9.

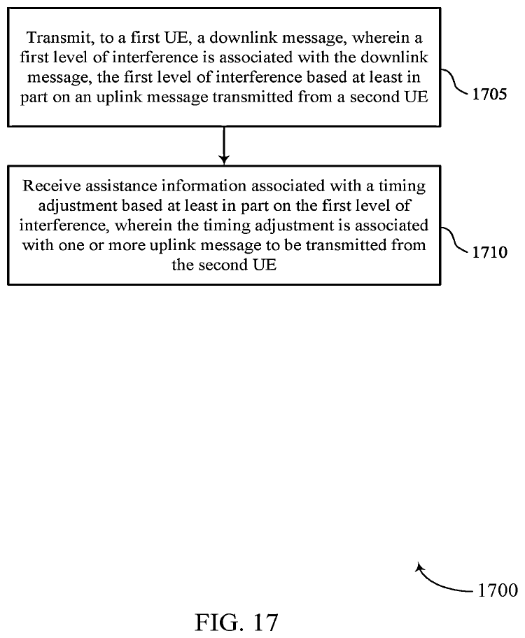

FIG. 17 shows a flowchart illustrating a method 1700 that supports UE indication of preferred timing adjustment in accordance with one or more aspects of the present disclosure. The operations of the method 1700 may be implemented by a network entity or its components as described herein. For example, the operations of the method 1700 may be performed by a network entity as described herein with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a first UE, a downlink message, where a first level of interference is associated with the downlink message, the first level of interference based at least in part on an uplink message transmitted from a second UE. The operations of 1705 may be performed in accordance with examples as disclosed herein. In some examples, aspects of the operations of 1705 may be performed by a downlink component 1325 as described herein with reference to FIG. 13.

At 1710, the method may include receiving assistance information associated with a timing adjustment based at least in part on the first level of interference, where the timing adjustment is associated with one or more uplink message to be transmitted from the second UE. The operations of 1710 may be performed in accordance with examples as disclosed herein. In some examples, aspects of the operations of 1710 may be performed by an assistance information component 1330 as described herein with reference to FIG. 13.

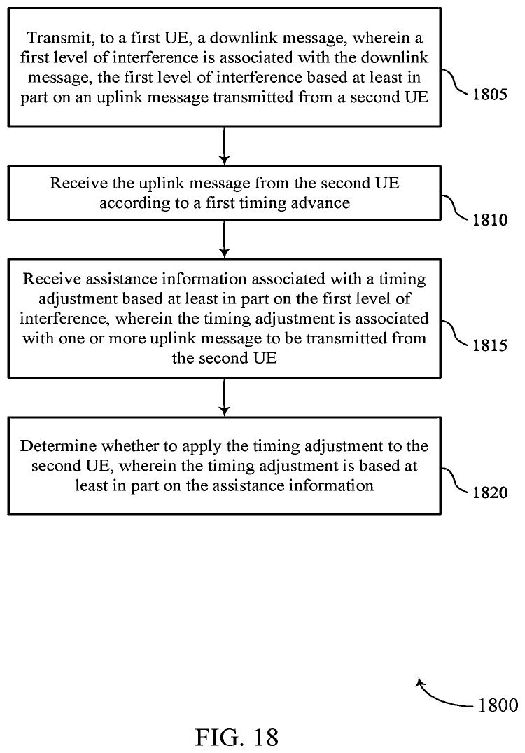

FIG. 18 shows a flowchart illustrating a method 1800 that supports UE indication of preferred timing adjustment in accordance with one or more aspects of the present disclosure. The operations of the method 1800 may be implemented by a network entity or its components as described herein. For example, the operations of the method 1800 may be performed by a network entity as described herein with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a first UE, a downlink message, where a first level of interference is associated with the downlink message, the first level of interference based at least in part on an uplink message transmitted from a second UE. The operations of 1805 may be performed in accordance with examples as disclosed herein. In some examples, aspects of the operations of 1805 may be performed by a downlink component 1325 as described herein with reference to FIG. 13.

At 1810, the method may include receiving the uplink message from the second UE according to a first TA. The operations of 1810 may be performed in accordance with examples as disclosed herein. In some examples, aspects of the operations of 1810 may be performed by an uplink component 1335 as described herein with reference to FIG. 13.

At 1815, the method may include receiving assistance information associated with a timing adjustment based at least in part on the first level of interference, where the timing adjustment is associated with one or more uplink message to be transmitted from the second UE. The operations of 1815 may be performed in accordance with examples as disclosed herein. In some examples, aspects of the operations of 1815 may be performed by an assistance information component 1330 as described herein with reference to FIG. 13.

At 1820, the method may include determining whether to apply the timing adjustment to the second UE, where the timing adjustment is based at least in part on the assistance information. The operations of 1820 may be performed in accordance with examples as disclosed herein. In some examples, aspects of the operations of 1820 may be performed by a timing adjustment component 1340 as described herein with reference to FIG. 13.

The following provides an overview of aspects of the present disclosure:

Aspect 1: A method for wireless communications at a first UE, comprising: receiving, from a network entity, a downlink message at the first UE; receiving a first level of interference at the first UE, wherein the first level of interference is based at least in part on an uplink message transmitted from a second UE and wherein the first level of interference at least partially overlaps in time with the downlink message; and transmitting, to the network entity, assistance information associated with a timing adjustment based at least in part on the first level of interference, wherein the timing adjustment is associated with one or more uplink messages to be transmitted from the second UE.

Aspect 2: The method of aspect 1, further comprising: comparing timing associated with reception of the downlink message to timing associated with reception of the first level of interference, wherein the assistance information is based at least in part on the comparison.

Aspect 3: The method of aspect 2, wherein transmitting the assistance information comprises: transmitting an indication of a value associated with the timing adjustment for the second UE, wherein the value associated with the timing adjustment is based at least in part on the comparison.

Aspect 4: The method of any of aspects 2 through 3, wherein transmitting the assistance information comprises: transmitting an indication of a timing report, wherein the timing report comprises an indication of a difference between the timing associated with the reception of the downlink message and the timing associated with the reception of the first level of interference based at least in part on the comparison.

Aspect 5: The method of any of aspects 1 through 4, wherein transmitting the assistance information comprises: transmitting, to the network entity, the assistance information associated with the timing adjustment based at least in part on a difference between the timing associated with the reception of the downlink message and the timing associated with the reception of the first level of interference exceeding a threshold, wherein the difference is based at least in part on the comparison.

Aspect 6: The method of any of aspects 1 through 5, further comprising: measuring the first level of interference, wherein transmitting the assistance information is based at least in part on the first level of interference exceeding a threshold.

Aspect 7: The method of aspect 6, further comprising: receiving, from the network entity, control signaling comprising an indication of the threshold.

Aspect 8: The method of aspect 6, wherein the threshold is based at least in part on one or more parameters at the first UE.

Aspect 9: The method of any of aspects 1 through 8, wherein transmitting the assistance information comprises: transmitting an indication of one or more parameters associated with the downlink message, the uplink message, or both, wherein the assistance information comprises the one or more parameters.

Aspect 10: The method of aspect 9, wherein the one or more parameters are associated with one or more guard bands, one or more guard symbols, one or more power control parameters, or any combination thereof.

Aspect 11: The method of any of aspects 1 through 10, further comprising: receiving, from the network entity, a second downlink message at the first UE; and receiving a second level of interference at the first UE based at least in part on the one or more uplink messages transmitted from the second UE, wherein the second level of interference is based at least in part on the assistance information.

Aspect 12: The method of aspect 11, wherein the second level of interference is less than a threshold.

Aspect 13: The method of any of aspects 11 through 12, wherein the downlink message is associated with a first transmission timing and receiving the second downlink message comprises: receiving the second downlink message associated with a second transmission timing, wherein the second transmission timing is based at least in part on the assistance information.

Aspect 14: The method of aspect 13, further comprising: receiving, from the network entity, a control message indicating the second transmission timing, wherein receiving the second downlink message is based at least in part on the control message.

Aspect 15: The method of any of aspects 1 through 14, wherein a difference between timing associated with the reception of the second downlink message and timing associated with the reception of the second level of interference is below a threshold.

Aspect 16: The method of any of aspects 1 through 15, wherein the downlink message is associated with a first sub-band and the uplink message is associated with a second sub-band.

Aspect 17: The method of any of aspects 1 through 16, further comprising: receiving, from the network entity, a feedback message indicating whether the network entity applied the timing adjustment to the second UE based at least in part on receiving the assistance information.

Aspect 18: A method for wireless communications at a network entity, comprising: transmitting, to a first UE, a downlink message, wherein a first level of interference is associated with the downlink message, the first level of interference based at least in part on an uplink message transmitted from a second UE; and receiving assistance information associated with a timing adjustment based at least in part on the first level of interference, wherein the timing adjustment is associated with one or more uplink message to be transmitted from the second UE.

Aspect 19: The method of aspect 18, further comprising: receiving the uplink message from the second UE according to a first TA; and determining whether to apply the timing adjustment to the second UE, wherein the timing adjustment is based at least in part on the assistance information.

Aspect 20: The method of aspect 19, further comprising: applying the timing adjustment to the second UE based at least in part on a value associated with the timing adjustment, wherein determining to apply the timing adjustment is based at least in part on the value being less than or equal to a threshold.

Aspect 21: The method of aspect 20, wherein applying the timing adjustment further comprises: transmitting, to the second UE, a control message indicating a second TA, wherein the second TA is based at least in part on the value associated with the timing adjustment; and receiving a second uplink message from the second UE according to the second TA.

Aspect 22: The method of aspect 19, wherein the downlink message is associated with a first transmission timing, the method further comprising: transmitting a second downlink message according to a second transmission timing, wherein the second transmission timing is based at least in part on a value associated with the timing adjustment.

Aspect 23: The method of any of aspects 18 through 22, wherein receiving the assistance information comprises: receiving an indication of a value associated with the timing adjustment for the second UE, wherein the assistance information comprises the indication.

Aspect 24: The method of any of aspects 18 through 23, wherein receiving the assistance information comprises: receiving an indication of a timing report, wherein the timing report comprises an indication of a difference between timing associated with reception of the downlink message by the first UE and timing associated with reception of the first level of interference by the first UE, wherein the assistance information comprises the timing report.

Aspect 25: The method of any of aspects 18 through 24, wherein receiving the assistance information comprises: receiving an indication of one or more parameters associated with the downlink message, the uplink message, or both, wherein the assistance information comprises the one or more parameters.

Aspect 26: The method of aspect 25, wherein the one or more parameters are associated with one or more guard bands, one or more guard symbols, one or more power control parameters, or any combination thereof.

Aspect 27: The method of any of aspects 18 through 26, further comprising: transmit, to a second network entity, the assistance information associated with the timing adjustment, wherein the second network entity is associated with the uplink message.

Aspect 28: The method of any of aspects 18 through 27, wherein the first level of interference exceeds a threshold.

Aspect 29: The method of any of aspects 18 through 28, wherein the downlink message is associated with a first sub-band and the uplink message is associated with a second sub-band.

Aspect 30: The method of any of aspects 18 through 29, further comprising: transmitting, to the first UE, a control message comprising an indication of a threshold associated with interference at the first UE.

Aspect 31: An apparatus for wireless communications at a first UE, comprising a processor; memory coupled with the processor; and instructions stored in the memory and executable by the processor to cause the apparatus to perform a method of any of aspects 1 through 17.

Aspect 32: An apparatus for wireless communications at a first UE, comprising at least one means for performing a method of any of aspects 1 through 17.

Aspect 33: A non-transitory computer-readable medium storing code for wireless communications at a first UE, the code comprising instructions executable by a processor to perform a method of any of aspects 1 through 17.

Aspect 34: An apparatus for wireless communications at a network entity, comprising a processor; memory coupled with the processor; and instructions stored in the memory and executable by the processor to cause the apparatus to perform a method of any of aspects 18 through 30.

Aspect 35: An apparatus for wireless communications at a network entity, comprising at least one means for performing a method of any of aspects 18 through 30.

Aspect 36: A non-transitory computer-readable medium storing code for wireless communications at a network entity, the code comprising instructions executable by a processor to perform a method of any of aspects 18 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a first user equipment (UE), comprising:
a processor; and
a memory coupled with the processor, with instructions stored in the memory, the instructions executable by the processor to cause the apparatus to:
receive, from a network entity, a downlink message at the first UE;
receive a first level of interference at the first UE, wherein the first level of interference is based at least in part on an uplink message transmitted from a second UE and wherein the first level of interference at least partially overlaps in time with the downlink message; and
transmit, to the network entity, assistance information associated with a timing adjustment based at least in part on the first level of interference, wherein the timing adjustment is associated with one or more uplink messages to be transmitted from the second UE.

2. The apparatus of claim 1, wherein the instructions are further executable by the processor to cause the apparatus to:
compare timing associated with reception of the downlink message to timing associated with reception of the first level of interference, wherein the assistance information is based at least in part on the comparison.

3. The apparatus of claim 2, wherein the instructions to transmit the assistance information are executable by the processor to cause the apparatus to:
transmit an indication of a value associated with the timing adjustment for the second UE, wherein the value associated with the timing adjustment is based at least in part on the comparison.

4. The apparatus of claim 2, wherein the instructions to transmit the assistance information are executable by the processor to cause the apparatus to:
transmit an indication of a timing report, wherein the timing report comprises an indication of a difference between the timing associated with the reception of the downlink message and the timing associated with the reception of the first level of interference based at least in part on the comparison.

5. The apparatus of claim 2, wherein the instructions to transmit the assistance information are executable by the processor to cause the apparatus to:
transmit, to the network entity, the assistance information associated with the timing adjustment based at least in part on a difference between the timing associated with the reception of the downlink message and the timing associated with the reception of the first level of interference exceeding a threshold, wherein the difference is based at least in part on the comparison.

6. The apparatus of claim 1, wherein the instructions are further executable by the processor to cause the apparatus to:
measure the first level of interference, wherein transmitting the assistance information is based at least in part on the first level of interference exceeding a threshold.

7. The apparatus of claim 6, wherein the instructions are further executable by the processor to cause the apparatus to:
receive, from the network entity, control signaling comprising an indication of the threshold.

8. The apparatus of claim 6, wherein the threshold is based at least in part on one or more parameters at the first UE.

9. The apparatus of claim 1, wherein the instructions to transmit the assistance information are executable by the processor to cause the apparatus to:
transmit an indication of one or more parameters associated with the downlink message, the uplink message, or both, wherein the assistance information comprises the one or more parameters.

10. The apparatus of claim 9, wherein the one or more parameters are associated with one or more guard bands, one or more guard symbols, one or more power control parameters, or any combination thereof.

11. The apparatus of claim 1, wherein the instructions are further executable by the processor to cause the apparatus to:
receive, from the network entity, a second downlink message at the first UE; and
receive a second level of interference at the first UE based at least in part on the one or more uplink messages transmitted from the second UE, wherein the second level of interference is based at least in part on the assistance information.

12. The apparatus of claim 11, wherein the second level of interference is less than a threshold.

13. The apparatus of claim 11, wherein the downlink message is associated with a first transmission timing and the instructions to receive the second downlink message are executable by the processor to cause the apparatus to:
receive the second downlink message associated with a second transmission timing, wherein the second transmission timing is based at least in part on the assistance information.

14. The apparatus of claim 13, wherein the instructions are further executable by the processor to cause the apparatus to:
receive, from the network entity, a control message indicating the second transmission timing, wherein receiving the second downlink message is based at least in part on the control message.

15. The apparatus of claim 11, wherein a difference between timing associated with the reception of the second downlink message and timing associated with the reception of the second level of interference is below a threshold.

16. The apparatus of claim 1, wherein the instructions are further executable by the processor to cause the apparatus to:
receive, from the network entity, a feedback message indicating whether the network entity applied the timing adjustment to the second UE based at least in part on receiving the assistance information.

17. An apparatus for wireless communications at a network entity, comprising:
a processor; and
a memory coupled with the processor, with instructions stored in the memory, the instructions executable by the processor to cause the apparatus to:
transmit, to a first user equipment (UE), a downlink message, wherein a first level of interference is associated with the downlink message, the first level of interference based at least in part on an uplink message transmitted from a second UE; and
receive assistance information associated with a timing adjustment based at least in part on the first level of interference, wherein the timing adjustment is associated with one or more uplink message to be transmitted from the second UE.

18. The apparatus of claim 17, wherein the instructions are further executable by the processor to cause the apparatus to:
receive the uplink message from the second UE according to a first timing advance; and
determine whether to apply the timing adjustment to the second UE, wherein the timing adjustment is based at least in part on the assistance information.

19. The apparatus of claim 18, wherein the instructions are further executable by the processor to cause the apparatus to:
apply the timing adjustment to the second UE based at least in part on a value associated with the timing adjustment, wherein determining to apply the timing adjustment is based at least in part on the value being less than or equal to a threshold.

20. The apparatus of claim 19, wherein the instructions to apply the timing adjustment are further executable by the processor to cause the apparatus to:
transmit, to the second UE, a control message indicating a second timing advance, wherein the second timing advance is based at least in part on the value associated with the timing adjustment; and
receive a second uplink message from the second UE according to the second timing advance.

21. The apparatus of claim 18, wherein the downlink message is associated with a first transmission timing, and the instructions are further executable by the processor to cause the apparatus to:
transmit a second downlink message according to a second transmission timing, wherein the second transmission timing is based at least in part on a value associated with the timing adjustment.

22. The apparatus of claim 17, wherein the instructions to receive the assistance information are executable by the processor to cause the apparatus to:
receive an indication of a value associated with the timing adjustment for the second UE, wherein the assistance information comprises the indication.

23. The apparatus of claim 17, wherein the instructions to receive the assistance information are executable by the processor to cause the apparatus to:
receive an indication of a timing report, wherein the timing report comprises an indication of a difference between timing associated with reception of the downlink message by the first UE and timing associated with reception of the first level of interference by the first UE, wherein the assistance information comprises the timing report.

24. The apparatus of claim 17, wherein the instructions to receive the assistance information are executable by the processor to cause the apparatus to:
receive an indication of one or more parameters associated with the downlink message, the uplink message, or both, wherein the assistance information comprises the one or more parameters.

25. The apparatus of claim 24, wherein the one or more parameters are associated with one or more guard bands, one or more guard symbols, one or more power control parameters, or any combination thereof.

26. The apparatus of claim 17, wherein the instructions are further executable by the processor to cause the apparatus to:
transmit, to a second network entity, the assistance information associated with the timing adjustment, wherein the second network entity is associated with the uplink message.

27. The apparatus of claim 17, wherein the first level of interference exceeds a threshold.

28. The apparatus of claim 17, wherein the instructions are further executable by the processor to cause the apparatus to:
transmit, to the first UE, a control message comprising an indication of a threshold associated with interference at the first UE.

29. A method for wireless communications at a first user equipment (UE), comprising:
receiving, from a network entity, a downlink message at the first UE;
receiving a first level of interference at the first UE, wherein the first level of interference is based at least in part on an uplink message transmitted from a second UE and wherein the first level of interference at least partially overlaps in time with the downlink message; and
transmitting, to the network entity, assistance information associated with a timing adjustment based at least in part on the first level of interference, wherein the timing adjustment is associated with one or more uplink messages to be transmitted from the second UE.

30. A method for wireless communications at a network entity, comprising:
transmitting, to a first user equipment (UE), a downlink message, wherein a first level of interference is associated with the downlink message, the first level of interference based at least in part on an uplink message transmitted from a second UE; and
receiving assistance information associated with a timing adjustment based at least in part on the first level of interference, wherein the timing adjustment is associated with one or more uplink message to be transmitted from the second UE.
